(19) United States
(12) Patent Application Publication
(10) Pub. No.: US 2014/0229252 A1
(43) Pub. Date: Aug. 14, 2014

(54) ALLOCATION OF CONTENT INVENTORY UNITS

(71) Applicant: Google Inc., Mountain View, CA (US)

(72) Inventors: Renato Gomes, Toulouse (FR); Martin Pal, Maplewood, NJ (US); Gagan Goel, New York, NY (US); Seyed Vahab Mirrokni Banadaki, New York, NY (US); Eyal Manor, Plainview, NY (US)

(73) Assignee: Google Inc., Mountain View, CA (US)

(21) Appl. No.: 13/763,310

(22) Filed: Feb. 8, 2013

(51) Int. Cl. G06Q 30/02

(52) U.S. Cl. CPC G06Q 30/0274
USPC 705/14.7

(57) ABSTRACT

This specification describes technologies relating to selection and delivery of online content. One aspect of the subject matter described in this specification can be embodied in methods that include determining a share fraction based on a received reserve price and based in part on a distribution of past bids for content inventory units in one or more content slots provided by a publisher. The methods may further include determining a second reserve price based in part on the received reserve price and based in part on a distribution of past bids for content inventory units in one or more content slots provided by the publisher. The methods may further include receiving one or more bids for the content inventory unit and allocating the content inventory unit to a buyer based in part on the one or more bids and the second reserve price.

### BACKGROUND

This disclosure relates to the selection and delivery of online content.

Online content can include web pages and advertisements displayed with the web pages. Content publishers have space that they sell to advertisers or other content providers directly or through intermediaries, such as brokers. Some of a publisher's available space may be sold through a remnant inventory marketplace. This remnant inventory market is a spot market that connects publishers with content providers (e.g., advertisers) in response to a request for content from a user. The publisher may communicate with one or more content providers or market intermediaries in an attempt to sell the space in time to serve content associated with the buyer.

### SUMMARY

This specification describes technologies relating to selection and delivery of online content items. In general, one aspect of the subject matter described in this specification can be embodied in a method that includes receiving a request for allocation of a content inventory unit in a content slot provided by a publisher. The method may further include receiving a first reserve price for the content inventory unit, where the first reserve price is a minimum payment that the publisher will accept for allocation of the content inventory unit. The method may further include determining a share fraction based in part on the first reserve price and based in part on a distribution of past bids for content inventory units in one or more content slots provided by the publisher. The method may further include determining a second reserve price based in part on the first reserve price and based in part on a distribution of past bids for content inventory units in one or more content slots provided by the publisher. The method may further include receiving one or more bids for the content inventory unit. The method may further include comparing at least one of the one or more bids to the second reserve price. The method may further include allocating the content inventory unit to a buyer based in part on the one or more bids and the second reserve price. The method may further include transmitting data reflecting the allocation of the content inventory unit to the buyer.

In general, one aspect of the subject matter described in this specification can be embodied in a system that includes a network interface configured to receive a request for allocation of a content inventory unit in a content slot provided by a publisher. The system may include a network interface configured to receive a first reserve price for the content inventory unit, where the first reserve price is a minimum payment that the publisher will accept for allocation of the content inventory unit. The system may include means for determining a share fraction based in part on the first reserve price and based in part on a distribution of past bids for content inventory units in one or more content slots provided by the publisher. The system may include means for determining a second reserve price based in part on the first reserve price and based in part on a distribution of past bids for content inventory units in one or more content slots provided by the publisher. The system may include a network interface configured to receive one or more bids for the content inventory unit. The system may include a module configured to compare at least one of the one or more bids to the second reserve price. The system may include a module configured to allocate the content inventory unit to a buyer based in part on the one or more bids and the second reserve price. The system may include a network interface configured to transmit data reflecting the allocation of the content inventory unit to the buyer.

In general, one aspect of the subject matter described in this specification can be embodied in a system that includes one or more data processing apparatus and a memory coupled to the one or more data processing apparatus. The memory having instructions

stored thereon which, when executed by the one or more data processing apparatus cause the one or more data processing apparatus to perform operations including receiving a request for allocation of a content inventory unit in a content slot provided by a publisher. The operations may further include receiving a first reserve price for the content inventory unit, where the first reserve price is a minimum payment that the publisher will accept for allocation of the content inventory unit. The operations may further include determining a share fraction based in part on the first reserve price and based in part on a distribution of past bids for content inventory units in one or more content slots provided by the publisher. The operations may further include determining a second reserve price based in part on the first reserve price and based in part on a distribution of past bids for content inventory units in one or more content slots provided by the publisher. The operations may further include receiving one or more bids for the content inventory unit. The operations may further include comparing at least one of the one or more bids to the second reserve price. The operations may further include allocating the content inventory unit to a buyer based in part on the one or more bids and the second reserve price. The operations may further include transmitting data reflecting the allocation of the content inventory unit to the buyer.

In general, one aspect of the subject matter described in this specification can be embodied in a non-transient computer readable media storing software including instructions executable by a processing device that upon such execution cause the processing device to perform operations that include receiving a request for allocation of a content inventory unit in a content slot provided by a publisher. The operations may further include receiving a first reserve price for the content inventory unit, where the first reserve price is a minimum payment that the publisher will accept for allocation of the content inventory unit. The operations may further include determining a share fraction based in part on the first reserve price and based in part on a distribution of past bids for content inventory units in one or more content slots provided by the publisher. The operations may further include

determining a second reserve price based in part on the first reserve price and based in part on a distribution of past bids for content inventory units in one or more content slots provided by the publisher. The operations may further include receiving one or more bids for the content inventory unit. The operations may further include comparing at least one of the one or more bids to the second reserve price. The operations may further include allocating the content inventory unit to a buyer based in part on the one or more bids and the second reserve price. The operations may further include transmitting data reflecting the allocation of the content inventory unit to the buyer.

These and other embodiments can each optionally include one or more of the following features. The sharing fraction may be determined based in part on a minimum cost associated with an auction platform. The sharing fraction may be determined based in part on a convex combination of expected revenue for the publisher and expected revenue for the auction platform. The buyer may pay the maximum of second reserve price and the second highest bid received for the content inventory unit. The content inventory unit may be allocated to the buyer based on the results of a truthful auction. The second reserve price may be determined based in part on a minimum cost associated with an auction platform. The second reserve price may be determined based in part on a convex combination of expected revenue for the publisher and the auction platform. The distribution of past bids may be limited to past bids for the content slot of the content inventory unit. Information reflecting a content item supplied by the buyer may be transmitted to a user device. The second reserve price may also be determined based in part on a distribution of past reserve prices received for content inventory units in one or more content slots provided by the publisher. The distribution of past reserve prices may be limited to past reserve prices for the content slot of the content inventory unit. The second reserve price may be determined based in part on the sharing fraction. A payment to the publisher may be determined based in part on the share fraction.

In general, one aspect of the subject matter described in this specification can be embodied in a method that includes obtaining revenue data for past allocations of content inventory units in a content slot provided by a publisher. The method may further include determining an exponent for a power law distribution based on the revenue data. The method may further include determining a constant sharing fraction based on the exponent. The method may further include allocating a content inventory unit in the content slot to a buyer. The method may further include determining a portion of a price paid for the content inventory unit by the buyer that is paid to the publisher using the constant sharing fraction. The method may further include transmitting data reflecting the allocation of the content inventory unit to the buyer.

In general, one aspect of the subject matter described in this specification can be embodied in a system that includes a module configured to obtain revenue data for past allocations of content inventory units in a content slot provided by a publisher. The system may include a module configured to determine an exponent for a power law distribution based on the revenue data. The system may include a module configured to determine a constant sharing fraction based on the exponent. The system may include a module configured to allocate a content inventory unit in the content slot to a buyer. The system may include a module configured to determine a portion of a price paid for the content inventory unit by the buyer that is paid to the publisher using the constant sharing fraction. The system may include a network interface configured to transmit data reflecting the allocation of the content inventory unit to the buyer.

In general, one aspect of the subject matter described in this specification can be embodied in a system that includes one or more data processing apparatus and a memory coupled to the one or more data processing apparatus. The memory having instructions stored thereon which, when executed by the one or more data processing apparatus cause the one or more data processing apparatus to perform operations including obtaining revenue data for past allocations of content inventory units in a content slot provided by a publisher. The operations may further include determining an exponent for a power law distribution based on the revenue data. The operations may further include determining a constant sharing fraction based on the exponent. The operations may further include allocating a content inventory unit in the content slot to a buyer. The operations may further include determining a portion of a price paid for the content inventory unit by the buyer that is paid to the publisher using the constant sharing fraction. The operations may further include transmitting data reflecting the allocation of the content inventory unit to the buyer.

In general, one aspect of the subject matter described in this specification can be embodied in a non-transient computer readable media storing software including instructions executable by a processing device that upon such execution cause the processing device to perform operations that include obtaining revenue data for past allocations of content inventory units in a content slot provided by a publisher. The operations may further include determining an exponent for a power law distribution based on the revenue data. The operations may further include determining a constant sharing fraction based on the exponent. The operations may further include allocating a content inventory unit in the content slot to a buyer. The operations may further include determining a portion of a price paid for the content inventory unit by the buyer that is paid to the publisher using the constant sharing fraction. The operations may further include transmitting data reflecting the allocation of the content inventory unit to the buyer.

These and other embodiments can each optionally include one or more of the following features. Determining the exponent for the power distribution may include using a maximum likelihood method to fit a power law distribution to the revenue data. Determining the constant sharing fraction based on the exponent may include dividing the exponent by one plus the exponent. The constant sharing fraction may be for all content slots provided by the publisher. Revenue data may be obtained for a plurality of content slots provided by the publisher. The constant sharing fraction may be for the content slot. The revenue data used to determine the exponent may be limited to revenue data for the content slot.

Particular embodiments of the subject matter described in this disclosure can be implemented to realize none, one or more of the following advantages. Content inventory unit inventory may be allocated to a buyer that may enhance revenue for the publisher. The number of content inventory units successfully allocated through an online content inventory unit auction platform may be increased compared to an auction platform that uses a single fixed sharing fraction for all auctions for inventory from all publishers. Revenue realized by an online content inventory unit auction platform may be increased compared to an auction platform that uses a single fixed sharing fraction for all auctions for inventory from all publishers. Revenue realized by a publisher may be increased while providing a required level of revenue to an online content inventory unit auction platform to satisfy a cost constraint. Revenue realized by both a publisher and an online content inventory unit auction platform may be jointly increased.

The details of one or more embodiments of the subject matter described in this disclosure are set forth in the accompanying drawings and the description below. Other features, aspects, and advantages will become apparent from the description, the drawings, and the claims.

### BRIEF DESCRIPTION OF THE DRAWINGS

FIG. 1 is a block diagram of an example online environment.

FIG. 2 is block diagram of an example spot market for remnant inventory.

FIG. 3 is a flowchart of an example process for allocating a content inventory unit to a buyer in response to a user request for content.

FIG. 4 is a flowchart of an example process for setting a constant sharing fraction for a publisher or content slot based on data corresponding to past content inventory unit allocations.

FIG. 5 is block diagram of an example computer system that can be used to facilitate the selection and delivery of content.

### DETAILED DESCRIPTION

Online content publishers try to derive as much revenue as they can from their available inventory (e.g. content inventory units in which advertisements or other content items may be presented). Publishers sell some of their inventory in guaranteed deals to individual content providers. The rest they generally provide to a number of different Market-Based Buyers (“MBBs”), who in turn sell to the highest bidder and pay the publisher some proportion of the received price. For example, MBBs can be yield managers or exchanges.

One type of MBB is an auction platform. An auction platform can allocate a content inventory unit by accepting bids from one or more potential buyers (e.g., advertisers, or demand-side platforms), selecting a winning bid and determining a buyer's price for the content inventory unit based on a set of rules called an auction mechanism. In some implementations, the auction mechanism may be designed to be truthful, in the sense that it incentivizes potential buyers to bid their true valuation of the content inventory unit. For example, a second-price auction may create an incentive for a potential buyer to bid their true valuation of a content inventory unit. The auction mechanism may also create incentives for a seller (e.g., a publisher) of a content inventory unit to reveal their true opportunity cost for allocating the content inventory unit through the auction platform by declaring a reserve price for the auction that is equal to this true opportunity cost. When a content inventory unit is allocated to a winner of one of these auctions, the winning buyer pays a price determined by the auction mechanism and this revenue may be shared by the publisher and the operator of the auction platform.

A sharing fraction is a value less than one that may be used to determine a portion of the revenue from a content inventory unit allocation that will be paid to the seller (e.g., the publisher of the content slot in which the content inventory unit occurs) of the content inventory unit. The compliment of the sharing fraction (e.g., one minus the sharing fraction) may be used to determine a portion of the revenue from a content inventory unit allocation that will be retained by an operator of the auction platform. Different sharing fractions may be used for different publishers. In some implementations, different sharing fractions may be used for each content slot. In some implementations, the sharing fraction for a publisher or for a particular content slot is a constant sharing fraction that has been determined based on historical revenue and/or opportunity cost data for content inventory units sold by the publisher or in the particular content slot respectively. In some implementations, a sharing fraction used for a particular content inventory unit may be determined after a request for allocation of the content inventory unit is received based in part on a reserve price declared by the seller for the content inventory unit. These newly generated sharing fractions may also be determined based in part on historical revenue and/or opportunity cost data for a relevant content slot or publisher.

When running an auction for a content inventory unit, the auction mechanism may use a second reserve price so that resulting allocations result in sufficient revenue to make a payment of at least the seller's declared reserve price and also provide some positive revenue for the operator of the auction platform. For example, the second reserve price may be determined to be the declared/received reserve price divided by the sharing fraction. One or more of the bids received as part of the auction may be compared to this second reserve price to determine whether an allocation of the content inventory unit to one of the bidding buyers will occur and/or to determine the amount of the payment that the winning bidder will make in exchange for the content inventory unit. In some implementations, the second reserve price is determined based in part on historical revenue and/or opportunity cost data for a relevant content slot or publisher. In some implementations, the second reserve price may be the same as the seller's declared reserve price.

In some implementations, the sharing fraction and/or the second reserve price used for a content inventory unit allocation may be chosen in a way that attempts to increase the revenue of the operator of an auction platform. In some implementations, the sharing fraction and/or the second reserve price used for a content inventory unit allocation may be chosen in a way that attempts to increase the revenue of a seller (e.g., a publisher). For example, the choice of the sharing fraction and/or the second reserve price may be adjusted to increase seller revenue subject to a constraint defined by a minimum cost associated with the auction platform that must be retained from the revenue for each content inventory unit. The sharing fraction and/or the second reserve price may be determined based in part on this minimum cost associated with the auction platform. In some implementations, the sharing fraction and/or the second reserve price used for a content inventory unit allocation may be chosen in a way that attempts to jointly increase the revenue of the operator of an auction platform and the revenue of the seller. For example, the sharing fraction and/or the second reserve price may be determined based in part on a convex combination of expected revenue for the seller and expected revenue for the operator of the auction platform. For example, processes for determining the sharing fraction and/or the second reserve price that attempts to increase various types of revenues are described in the EXAMPLE AUCTION MODELS sections below.

Where the choice of the sharing fraction and/or the second reserve price depends on the a theoretical distribution of content inventory unit valuations (e.g., the distribution of actual seller opportunity costs or the distribution of a potential buyer's valuations), these distributions may be approximated by determining an empirical distribution of past indicators of the parties' valuations that have been presented during past auctions of content inventory units in a relevant content slot or associated with a relevant publisher. In some implementations, the distribution of a potential buyer's content inventory unit valuations is approximated by a distribution of past bids submitted for content inventory units in one or more relevant content slots by one or more buyers. In some implementations, the distribution of a seller's true opportunity cost is approximated by a distribution of past reserve prices declared for content inventory units in one or more relevant content slots by one or more sellers. In some implementations, the storage space required for maintaining an empirical distribution may be reduced by quantizing the distribution. For example, valuation or revenue data points may be categorized into bins corresponding to ranges of values.

For example, suppose a website server receives a request from a user device for a webpage including at least one content slot. The website seeks to increase its revenue by finding an advertiser willing to pay the highest price for serving its advertisement in this content slot (e.g., buying the content inventory unit). The website may survey its options from among its existing agreements with advertisers and also in the spot market for remnant inventory. Based on this information, the website may form a belief as to its opportunity cost of sending the content inventory unit to a particular MBB for allocation. The website may then submit a request for allocation of the content inventory unit to an auction platform in this spot market, along with a reserve price that corresponds to the website's opportunity cost. The auction platform may determine a sharing fraction for this content inventory unit based on the reserve price received from the publisher, a distribution of past bids for content inventory units in this content slot, a distribution of past reserve prices declared for content inventory units in the content slot, and a minimum cost associated with the auction platform. The sharing fraction may be determined in a manner that attempts to increase a convex combination of revenue for the seller and revenue for the operator of the auction platform. A second reserve price may be determined as the received reserve price divided by the sharing fraction. Bids may then be received from a set of potential buyers of the content inventory unit (e.g., advertisers). If the highest bid is greater than the second reserve price, then the content inventory unit may be allocated to the highest bidder. The price paid by the highest bidder (the winner) for the content inventory unit may be the maximum of the second reserve price and the second highest bid received. The sharing fraction times the price paid by the winner may then be paid to the website, while the remainder of the revenue from allocation of the content inventory unit is retained by the operator of the auction platform. The winner is allocated the content inventory unit and the winner's advertisement is presented to a user through display on the user device in the content slot within the requested webpage.

A content item is any data that can be provided over a network. For example, an advertisement, including a link to a landing page is a content item. The processes described below are illustratively applied to content items that are advertisements provided in response to a request from an online resource, but the processes are also applicable to other content items provided over a network.

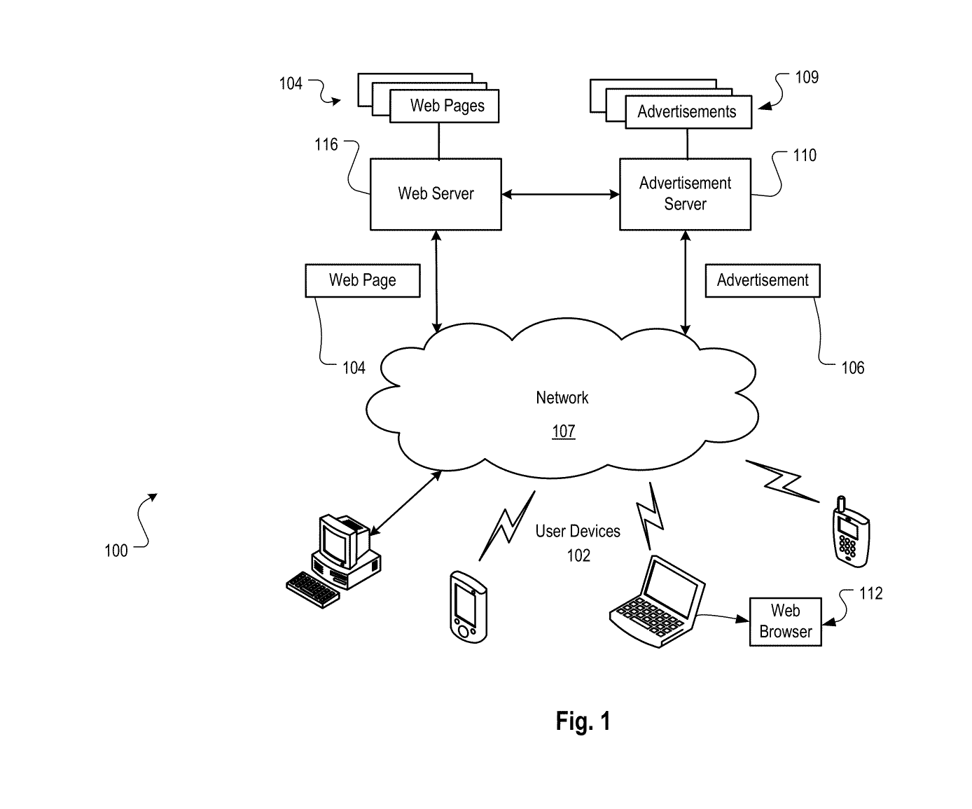

FIG. 1 is a block diagram of an example online environment 100 that facilitates the serving of content items for display on user devices 102. For example, content items can include web pages 104 and advertisements 106 (e.g., advertisements related to the web pages 104).

Web pages 104 and advertisements 106 can be provided to user devices 102 through a network 107 (e.g. a wide area network, local area network, the Internet, or any other public or private network, or combination of both.) User devices 102 can connect to a web server 116 (or an advertisement server 110) through the network 107 using any device capable of communicating in a computer network environment and displaying retrieved information. Example user devices 102 include a web-enabled handheld device, a mobile telephone or smartphone, tablet device, a set top box, a game console, a personal digital assistant, a navigation device, or a computer.

Web pages 104 can be provided by a web server 116 for display on a user device 102, and advertisements 106 can be provided by the advertisement server 110 for display on the user device 102. In some implementations, the advertisements 106 are provided directly to the web server 116 by the advertisement server 110, and the web server 116 then provides the advertisements 106 to the user devices 102 in association with one or more particular web pages 104, e.g., web pages which are related to the advertisements 106. In some implementations, the web server 116 queries the advertisement server 110 for advertisements 106 related to one or more particular web pages 104, and the advertisement server 110 evaluates a pool 109 of advertisements and chooses one or more advertisements 106 that are related to the web pages 104, e.g. advertisements that pertain to subject matter referenced by or described within the web pages 104. The advertisements 106 can be displayed with the web page 104 on a web browser 112 of a user device 102. The advertisements 106 can also be requested as part of the delivery of a web page 104 in response to a user device 102 requesting the web page 104 from a web server 116.

The content served by online publishers can take many other forms. For example, content items may include one or more media formats, including web pages, portions of web pages, banners, text, HTML page address pointers, hypertext, audio content, visual content, buttons, pop-up windows, placement within sponsored search listings, streaming media (including video and/or audio), and combinations thereof. Ads are content that advertisers may pay to have paired and delivered with other publisher content to users or consumers. Ads can be in any of the media formats that other content occurs in. While reference is made herein to the delivery of ads, other forms of content including other forms of sponsored content can be delivered by the systems and methods proposed.

When a user requests online content (e.g., a web page or another online resource), content requests can be initiated to request content from a content publisher for presentation on a user device. For example, content publishers can include publishers of web sites or search engines that are publishing search results responsive to a query. One or more additional content items (e.g., ads) can be provided along with the requested content. As a result, the presented content can include, for example, text, images, audio, video, advertisements (or ads) or other content selected for presentation to the user. In response to each content request received, content can be served, including one or more ads. Ads may advertise a product or service, on behalf of an advertiser, in a format that may entice an action (e.g., clicking, buying, etc.) by the user who sees the ad.

A content inventory unit is a unit of content (e.g., ad) space inventory. For example, a content inventory unit occurs when an ad is delivered, usually with accompanying content, to a user. A content inventory unit may have a number of characteristics, such as

characteristics of the requested content to be paired with the secondary content (e.g., ad), the timing of the user request and corresponding delivery of content, and characteristics of the user who requested the content, such as demographic information and geographic location. A single user request for content may initiate multiple content inventory units. For example, as user request for a web page may allow a publisher to deliver multiple ads that are displayed in different locations within the rendered web page. In some implementations, a system can record an indication of each delivered content inventory unit, such as for accounting purposes.

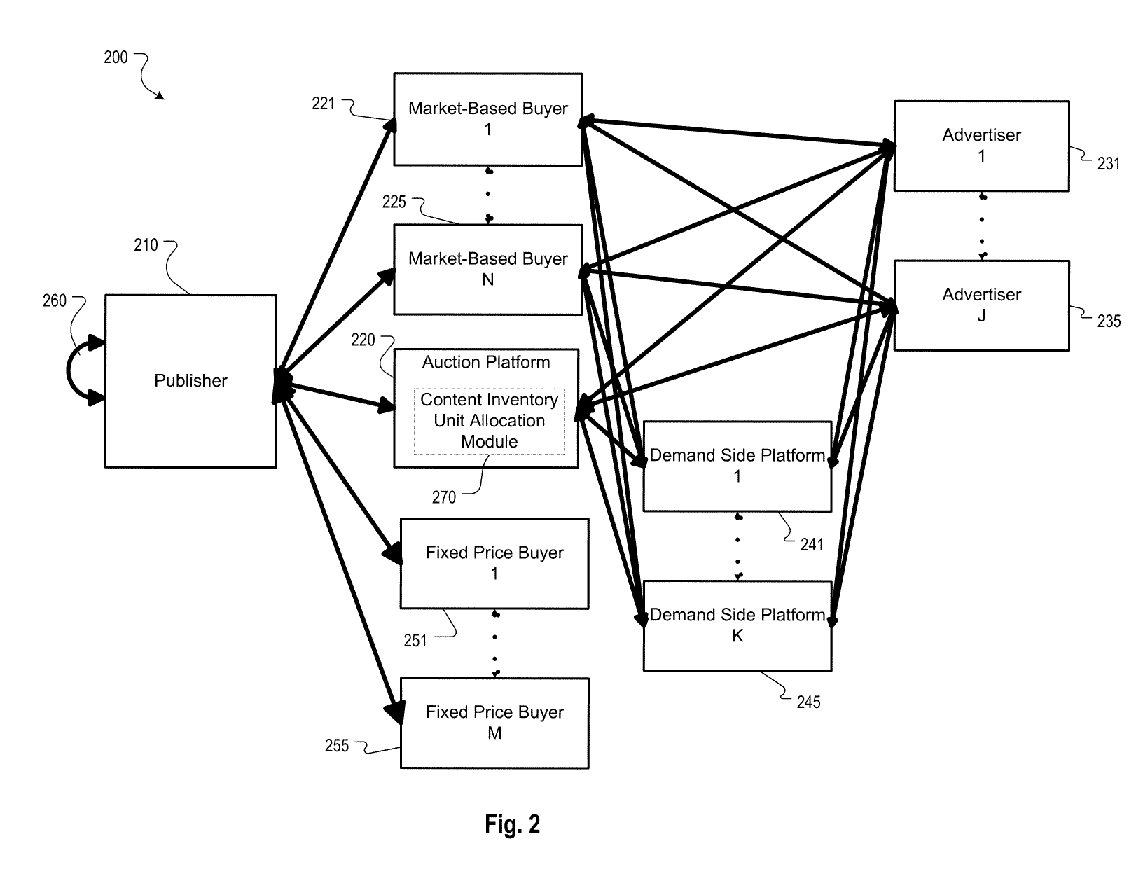

A publisher may operate a server, such as web server 116, for delivering content to users. The publisher may also operate an ad server, such as advertisement server 110, or may direct users to ads served from ad servers operated by other entities. When a publisher has remnant inventory, it often seeks to sell that inventory in real time on a spot market. FIG. 2 is a block diagram of an example spot market for remnant inventory. The figure depicts the relationships between participants in the market. The lines in the figure represent transactions in which content inventory units are exchanged for content and revenue. Typically a content inventory unit, or information describing a content inventory unit, flows from left to right across the market via one or more transactions. In return a content item (e.g., an ad), or information concerning a content item, that will be served in the content inventory unit and revenue flow back to the publisher via the same transaction pathway.

A Publisher 210 sells remnant content inventory units to buyers. Usually, the Publisher 210 allocates a content inventory unit to an MBB, such as auction platform 220, MBB 221, or MBB 225. The MBB in turn sells the content inventory unit to a content provider (e.g., Advertiser 231 or 235) either directly or through another intermediary, such as a Demand-Side Platform (“DSP”) (e.g., DSP 241 or DSP 245). Content networks may act as DSPs in some implementations. The MBB can conduct an auction for the content inventory unit, selling the content inventory unit to, for example, the highest bidder. The MBB 221, for example, then provides a portion of the revenues from the sale to the publisher 210. The advertiser 231, for example, that ultimately buys the content inventory unit, gets to have one of its ads served or delivered to the user in the content inventory unit.

In some cases the publisher 210 may sell a remnant content inventory unit to a buyer who is offering a fixed price for qualifying remnant content inventory units. These Fixed-Price Buyers (“FPBs”) (e.g., FPB 251 or FPB 255), when present, offer the benefit of relatively certain revenue. FPBs may have limited demand and be unavailable as an allocation option for some remnant content inventory units. For example, FPBs may only buy a certain number of content inventory units per day, and only certain types of content inventory units. FPBs may be individual advertisers or some type of market intermediary, for example.

In some cases the publisher 210 may elect to allocate remnant inventory to itself by serving or delivering a house content item in the content inventory unit. The looping transaction 260 represents this self-allocation option. House content can be considered content maintained by the publisher that may be substituted for revenue generating third party content in a content inventory unit. A house content item may not directly generate revenue for the publisher, but may provide other benefits to the publisher. The value of these other benefits may be estimated with an equivalent revenue model for comparison with other options when deciding how the publisher will allocate a content inventory unit. Setting revenue equivalence for house content also allows the publisher 210 to control the pricing of its inventory by setting a floor for expected revenues from a content inventory unit.

In summary, a publisher 210 who seeks to sell a remnant content inventory unit on this spot market 200 generally has three types of options. The publisher may allocate the content inventory unit to (1) an MBB (e.g., MBB 221), (2) an FPB (e.g., FPB 251), or (3) itself by serving a house content item 260. The maximum of the expected revenues to be realized from each of these alternative options is the opportunity cost that the publisher has for allocating the content inventory unit to a particular buyer in the spot market, e.g., auction platform 220. If auction platform 220 implements a truthful auction mechanism with reserve prices, the publisher 210 may be incentivized to declare a reserve price equal to the publisher's opportunity cost when the publisher submits a request further allocation of the content inventory unit by the auction platform 220. This may guarantee that the publisher 210 will receive at least its opportunity cost for the content inventory unit if the content inventory unit is successfully allocated by the auction platform 220.

The auction platform 220 may use a content inventory unit allocation module 270 to implement an auction mechanism and allocate the content inventory unit in a systematic and efficient manner. For example, the content inventory unit allocation module 270 may determine a sharing fraction and/or a second reserve price based on the reserve price received from the publisher 210, a distribution of past bids for content inventory units for a relevant content slot or the publisher 210, and a distribution of past reserve prices declared for content inventory units for a relevant content slot or the publisher 210, and a minimum cost associated with the auction platform 220. The sharing fraction and/or the second reserve price may be used to allocate the content inventory unit to a winning buyer (e.g., advertiser 231) and determine the price paid by the buyer and the amount of these revenues that are to be paid to the publisher 210.

The content inventory unit allocation module 270 may record data regarding the transaction for accounting purposes or for use in updating distributions of bids and/or reserve prices. The information saved may include the reserve price received from the seller, the bids received, an identification of the buyer, and/or information about the content inventory unit, such as an identification of the content slot and the publisher, the time, or user characteristics. This transaction data may be stored directly in a record associated with a particular publisher or content slot. In some implementations, the information may be stored in a log of transactions that is processed periodically to update system parameters, such as distributions of bids and/or reserve prices.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

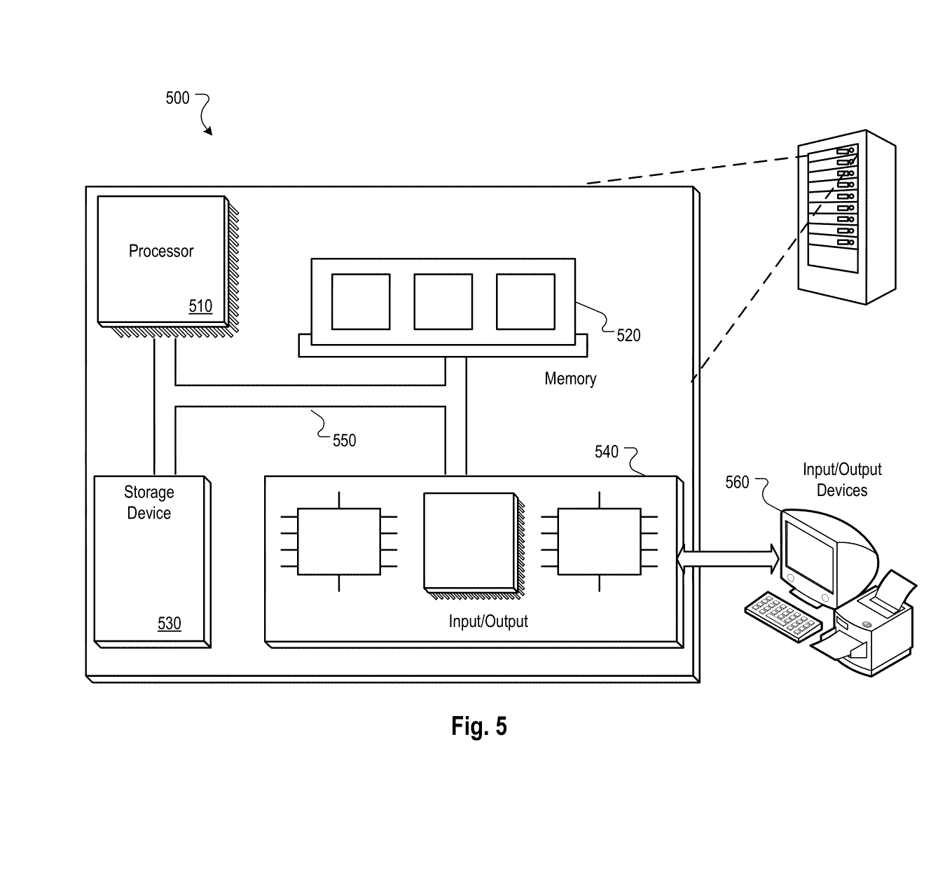

The content inventory unit allocation module 270 may be implemented in a variety of hardware and software configurations. For example, it may be implemented in software running on a dedicated processing system that is connected to a network, such as the Internet. The content inventory unit allocation module 270 may also be implemented in software that runs on a processing system utilized for other functionality, such as a web server 116 or an Ad server 110. In some implementations a content inventory unit allocation module 270 may run on a single processing device, such as the processing described below with reference to FIG. 5. In some implementations, a content inventory unit allocation module 270 may run on a on a multiple processing devices that communicate over a network and form a distributed computing system.

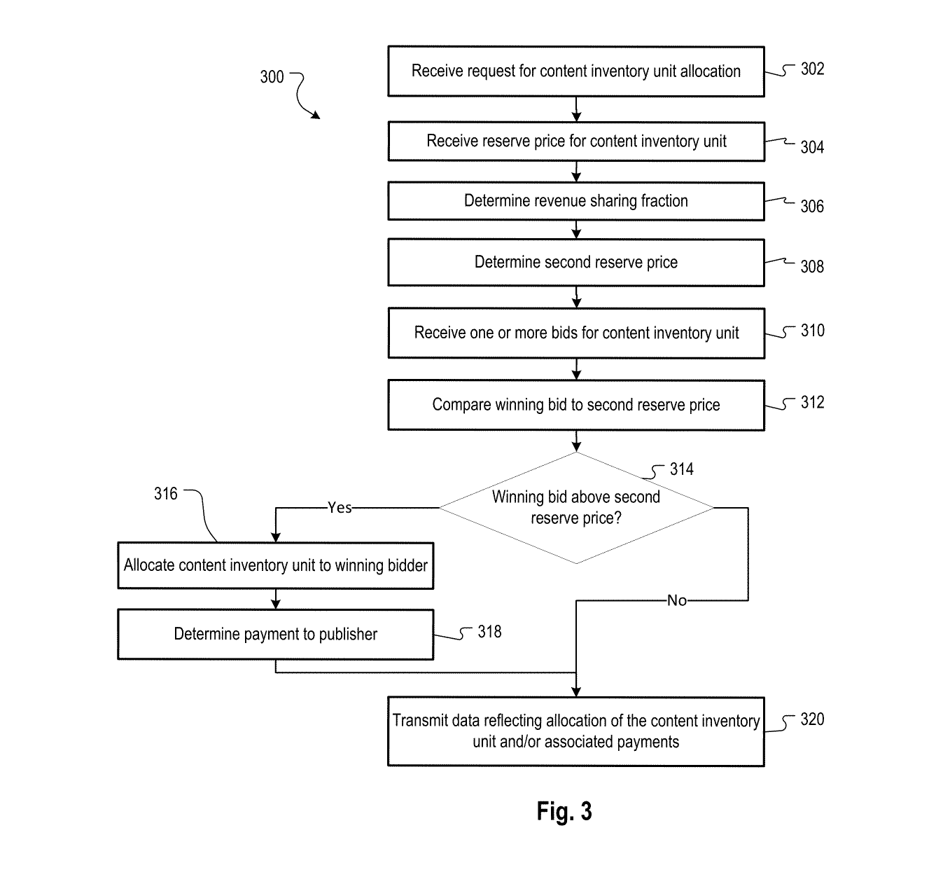

FIG. 3 is a flow chart of an example process 300 for allocating a remnant content inventory unit to a buyer in response to a request. The remnant content inventory unit allocation process 300 may be performed by the content inventory unit allocation module 270. Operations commence when the auction platform receives 302 a request for a content inventory unit to be allocated. For example, the request for content inventory unit allocation may be received from a publisher. In other examples, the request may be received from an advertisement management system, or directly from a user device requesting content including the content inventory unit, among other possible sources. The process 300 may be performed for each content inventory unit implicated by a user request for content. For example, the request may be received 304 through a network interface of the auction platform 220.

A reserve price is received 304 as part of the request or in a related communication. The reserve price may correspond to a minimum amount of revenue that will be accepted in exchange for the content inventory unit. In some implementations, the reserve price is declared by the publisher of the content in which the content slot of the content inventory unit occurs. The reserve price may be received from the publisher's server system or from another device associated with the request for allocation of the content inventory unit. For example, the reserve price may be received 304 through a network interface of the auction platform 220.

A sharing fraction for revenues resulting from the allocation of the content inventory unit is determined 306. The sharing fraction specifies the portion of revenues resulting from the allocation of the content inventory unit to a buyer that will be paid to the publisher selling the content inventory unit. The sharing fraction may be specific to the particular content slot in the sense that it may be determined based on a distribution of historical valuation data for only content inventory units in that content slot. The sharing fraction may be specific to the particular publisher in the sense that it may be determined based on a distribution of historical valuation data for only content inventory units in content slots provided by that publisher.

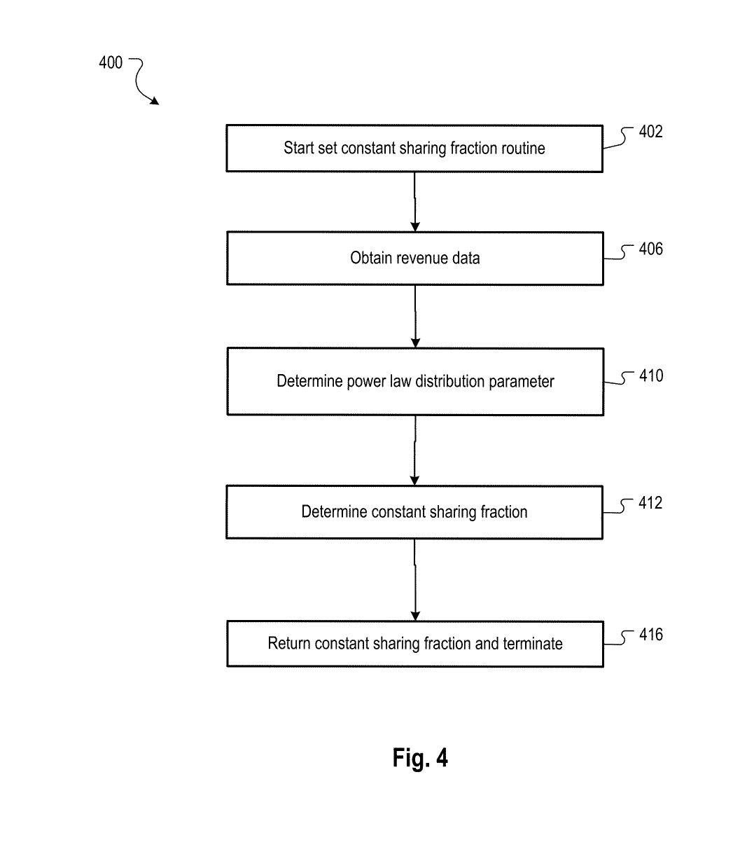

In some implementations, the sharing fraction is determined 306 by retrieving a constant sharing function for the particular publisher or content slot for the content inventory unit. The constant sharing fraction is “constant” in the sense that it does not vary based on the declared reserve price for a current content inventory unit that is being allocated based in part on the constant sharing fraction. The constant sharing function may depend on past revenue data, which may include past reserve prices for past content inventory units that have previously been allocated. In some implementations, the revenue data includes bids on past content inventory units and/or prices paid by winning bidders for past content inventory units. For example, a constant sharing fraction may have been determined using a process 400 described in relation to FIG. 4.

In some implementations, the sharing fraction is determined 306 based in part on the received reserve price for the current content inventory unit. The sharing fraction may also be determined based in part on a distribution of bids for past content inventory units in one or more associated content slots (e.g., content inventory units in the same content slot as the current content inventory unit or content inventory units in multiple content slots provided by the same publisher). A subset of the bids received for these past content inventory units may be considered (e.g., only the highest bid on each past content inventory unit, or only the second highest bid for each content inventory unit in second-price auctions). In some implementations, the sharing fraction may also be determined based in part on a distribution of past reserve prices received for content inventory units in one or more associated content slots (e.g., content inventory units in the same content slot as the current content inventory unit or content inventory units in multiple content slots provided by the same publisher). For example, the sharing fraction (λ) may be determined in a manner that attempts to increase revenues for the operator of the auction platform, as described in Section 1 of The EXAMPLE AUCTION MODELS described below. For example, the sharing fraction may be determined according to:

$$λ ( {v}_{0} ) \cdot {\int }_{r ( {v}_{0} )}^{b} \{ v - \frac{1 - F ( v )}{f ( v )} \} f ( v ) \cdot {F}^{N - 1} ( v ) d e = 1 - {F}^{N} ( r ( {v}_{0} ) ) + {\int }_{{v}_{0}}^{b} ( 1 - {F}^{N} ( r ( \hat{v} ) ) d \hat{v} .$$

where λ(v₀) is the sharing fraction, v₀ is the reserve price received from a seller, F( ) is an estimated cumulative distribution of bids received from a buyer (e.g., based on a histogram of past bids for related past content inventory units), f( ) is an estimated probability mass function for bids received from a buyer (e.g., based on a histogram of past bids for related past content inventory units), b is the highest past bid in a set of bids for related past content inventory units, r(v₀) is a second reserve price based on the received reserve price (e.g., determined as describe below), and N is a model parameter reflecting the number of buyers expected to potentially bid on the content inventory unit. In some implementations, this equation may be solved using numerical methods to determine a sharing fraction.

In some implementations, the sharing fraction is determined based in part on a minimum cost associated with an auction platform. For example, the auction platform may include a set of networked processing devices (e.g., like the processing device of FIG. 5) and there may be costs associated with maintaining and operating these devices. These costs may be amortized over an expected number of content inventory unit allocation transactions to determine a minimum cost (K) that must be recouped by the operator of the auction platform in each transaction or over a certain period of time. In some implementations, the sharing fraction is determined in a manner that attempts to increase profits of the seller, subject to the constraint that the operator of the auction platform retains revenues of at least the minimum cost (K). For example, the sharing fraction (λ) may be determined in a manner that attempts to increase revenues for the seller, as described in Section 2 of The EXAMPLE AUCTION MODELS described below. For example, the sharing fraction may be determined according to:

$$λ ( {v}_{0} , K ) \cdot {\int }_{s ( {v}_{0} , λ ( K ) )}^{b} \{ v - \frac{1 - F ( v )}{f ( v )} \} f ( v ) \cdot {F}^{N - 1} ( v ) d v = 1 - {F}^{N} ( s ( {v}_{0} , λ ( K ) ) ) + {\int }_{{v}_{0}}^{b} ( 1 - {F}^{N} ( s ( \hat{v} , λ ( K ) ) ) d \hat{v} . \\ with \\ s ( {v}_{0} , λ ) - \frac{1 - F ( s ( {v}_{0} , λ ) )}{f ( s ( {v}_{0} , λ ) )} = {v}_{0} + λ \cdot \frac{G ( {v}_{0} )}{g ( {v}_{0} )} .$$

where λ(v₀, K)=λ(K)=λ, is the sharing fraction, v₀ is the reserve price received from a seller, K is the minimum cost, F( ) is an estimated cumulative distribution of bids received from a buyer (e.g., based on a histogram of past bids for related past content inventory units), f( ) is an estimated probability mass function for bids received from a buyer (e.g., based on a histogram of past bids for related past content inventory units), b is the highest past bid in a set of bids for related past content inventory units, s(v, λ) is a second reserve price based on the received reserve price and the sharing fraction (e.g., determined as describe below), G( ) is an estimated cumulative distribution of reserve prices received from a seller (e.g., based on a histogram of past reserve prices for related past content inventory units), g( ) is an estimated probability mass function for reserve prices received from a seller (e.g., based on a histogram of past reserve prices for related past content inventory units), and N is a model parameter reflecting the number of buyers expected to potentially bid on the content inventory unit. In some implementations, these equations may be solved using numerical methods to determine a sharing fraction A and a second reserve price s.

In some implementations, the sharing fraction is determined to increase a convex combination of expected revenue for the publisher and expected revenue for the auction platform. The sharing fraction may be determined based in part on a convex combination of expected revenues for the seller (e.g., a publisher) and expected revenue for the operator of the auction platform. For example, the sharing fraction may depend on:

αE(Rₛ)+(1−α)E(Rₚ)

where α is a mixing parameter between zero and one that may be configured to emphasize seller revenue relative to auction platform revenue, E(Rₛ) is an expected seller revenue derived from distributions of bids and/or reserve prices for a relevant content slot or publisher, and E(Rₚ) is an expected revenue for an auction platform operator derived from distributions of bids and/or reserve prices for a relevant content slot or publisher.

For example, the sharing fraction (θ) may be determined in a manner that attempts to jointly optimize revenues for the seller and the revenues for the operator of the auction platform subject to a minimum cost constraint, as described in Section 3 of The EXAMPLE AUCTION MODELS described below. For example, where the minimum cost is zero, the sharing fraction may be determined according to:

$${θ}^{α} ( \hat{r} ) = \frac{b - {v}_{0}^{α} ( \hat{r} ) \cdot {F}^{N} ( \hat{r} ) - {\int }_{{v}_{0}^{α} ( \hat{r} )}^{b} {F}^{N} ( r ( \hat{v} ) ) d \hat{v}}{R ( \hat{r} , \text{\textbar} N )}$$

$$for$$

$$\hat{r} ∈ [ \underline{r} , b ] and {θ}^{α} ( \hat{r} ) = 0 for \hat{r} < \underline{r} .$$

where θ^{α}( ) is the sharing fraction for a given mixing parameter, \hat{r} is a reserve price received from a seller, b is the highest past bid in a set of bids for related past content inventory units, a is the lowest past bid in a set of bids for related past content inventory units, r is defined a solution of:

$$\underline{r} - \frac{1 - F ( \underline{r} )}{f ( \underline{r} )} = a$$

or r=a, if the above equation does not admit a solution in [a,b], v₀^{α}( ) is defined as a solution of:

$$r - \frac{1 - F ( r )}{f ( r )} = {v}_{0}^{α} ( r ) + h ( α ) \cdot \frac{G ( {v}_{0}^{α} ( r ) )}{g ( {v}_{0}^{α} ( r ) )}$$

F( ) is an estimated cumulative distribution of bids received from a buyer (e.g., based on a histogram of past bids for related past content inventory units), f( ) is an estimated probability mass function for bids received from a buyer (e.g., based on a histogram of past bids for related past content inventory units), G( ) is an estimated cumulative distribution of reserve prices received from a seller (e.g., based on a histogram of past reserve prices for related past content inventory units), g( ) is an estimated probability mass function for reserve prices received from a seller (e.g., based on a histogram of past reserve prices for related past content inventory units), h(α) is defined as:

$$h ( α ) = \{ \begin{matrix}\frac{1 - 2 - α}{1 - α} & if α \leq \frac{1}{2} \\ 0 & if α > \frac{1}{2} .\end{matrix}$$

R(r,N) is defined as:

$$R ( r , N ) ≡ N \cdot {\int }_{r}^{b} \{ v - \frac{1 - F ( v )}{f ( v )} \} f ( v ) \cdot {F}^{N - 1} ( v ) d v . ,$$

and N is a model parameter reflecting the number of buyers expected to potentially bid on the content inventory unit. In some implementations, these equations may be solved using numerical methods to determine a sharing fraction θ.

For example, the sharing fraction may be determined 306 by the content inventory unit allocation module 270 of the auction platform 220.

A second reserve price may be determined 308. The second reserve price is a minimum price that must be paid by a buyer for the current content inventory unit. The second reserve price may be specific to the particular content slot in the sense that it may be determined based on a distribution of historical valuation data for only content inventory units in that content slot. The second reserve price may be specific to the particular publisher in the sense that it may be determined based on a distribution of historical valuation data for only content inventory units in content slots provided by that publisher.

In some implementations, the second reserve price is determined based in part on the sharing fraction. For example, the second reserve price may be calculated as the reserve price received from a seller of the content inventory unit divided by the sharing fraction. Thus, in this example, the second reserve price is determined based in part on all of the things that the sharing fraction was determined based on.

In some implementations, the second reserve price is determined to be equal to the reserve price received from the seller of the content inventory unit.

In some implementations, the second reserve price is determined based in part on the received reserve price for the content inventory unit. The second reserve price may also be determined based in part on a distribution of bids for past content inventory units in one or more associated content slots (e.g., content inventory units in the same content slot as the current content inventory unit or content inventory units in multiple content slots provided by the same publisher). A subset of the bids received for these past content inventory units may be considered (e.g., only the highest bid on each past content inventory unit, or only the second highest bid for each content inventory unit in second-price auctions). In some implementations, the second reserve price may also be determined based in part on a distribution of past reserve prices received for content inventory units in one or more associated content slots (e.g., content inventory units in the same content slot as the current content inventory unit or content inventory units in multiple content slots provided by the same publisher). For example, the second reserve price (r) may be determined in a manner that attempts to increase revenues for the operator of the auction platform, as described in Section 1 of The EXAMPLE AUCTION MODELS described below. For example, the second reserve price may be determined according to:

$$r ( {v}_{0} ) - \frac{1 - F ( r ( {v}_{0} ) )}{f ( r ( {v}_{0} ) )} = {v}_{0} + \frac{G ( {v}_{0} )}{g ( {v}_{0} )} .$$

where r(v₀) is the second reserve price, v₀ is the reserve price received from a seller, F( ) is an estimated cumulative distribution of bids received from a buyer (e.g., based on a histogram of past bids for related past content inventory units), f( ) is an estimated probability mass function for bids received from a buyer (e.g., based on a histogram of past bids for related past content inventory units), G( ) is an estimated cumulative distribution of reserve prices received from a seller (e.g., based on a histogram of past reserve prices for related past content inventory units), and g( ) is an estimated probability mass function for reserve prices received from a seller (e.g., based on a histogram of past reserve prices for related past content inventory units). In some implementations, this equation may be solved using numerical methods to determine a second reserve price.

In some implementations, the second reserve price is determined based in part on a minimum cost associated with an auction platform. In some implementations, the second reserve price is determined in a manner that attempts to increase profits of the seller, subject to the constraint that the operator of the auction platform retains revenues of at least the minimum cost (K). For example, the second reserve price (r) may be determined in a manner that attempts to increase revenues for the seller, as described in Section 2 of The EXAMPLE AUCTION MODELS described below. For example, the second reserve price may be determined according to:

$$λ ( {v}_{0} , K ) \cdot {\int }_{s ( {v}_{0} , λ ( K ) )}^{b} \{ v - \frac{1 - F ( v )}{f ( v )} \} f ( v ) \cdot {F}^{N - 1} ( v ) d v = 1 - {F}^{N} ( s ( {v}_{0} , λ ( K ) ) ) + {\int }_{{v}_{0}}^{b} ( 1 - {F}^{N} ( s ( \hat{v} , λ ( K ) ) ) d \hat{v} . \\ with s ( {v}_{0} , λ ) - \frac{1 - F ( s ( {v}_{0} , λ ) )}{f ( s ( {v}_{0} , λ ) )} = {v}_{0} + λ \cdot \frac{G ( {v}_{0} )}{g ( {v}_{0} )} .$$

where λ(v₀, K)=λ(K)=λ is the sharing fraction, v₀ is the reserve price received from a seller, K is the minimum cost, F( ) is an estimated cumulative distribution of bids received from a buyer (e.g., based on a histogram of past bids for related past content inventory units), f( ) is an estimated probability mass function for bids received from a buyer (e.g., based on a histogram of past bids for related past content inventory units), b is the highest past bid in a set of bids for related past content inventory units, s(v, λ) is a second reserve price based on the received reserve price and the sharing fraction (e.g., determined as describe below), G( ) is an estimated cumulative distribution of reserve prices received from a seller (e.g., based on a histogram of past reserve prices for related past content inventory units), g( ) is an estimated probability mass function for reserve prices received from a seller (e.g., based on a histogram of past reserve prices for related past content inventory units), and N is a model parameter reflecting the number of buyers expected to potentially bid on the content inventory unit. In some implementations, these equations may be solved using numerical methods to determine a sharing fraction A and a second reserve price s.

In some implementations, the second reserve price is determined to increase a convex combination of expected revenue for the publisher and expected revenue for the auction platform. The second reserve price may be determined based in part on a convex combination of expected revenues for the seller (e.g., a publisher) and expected revenue for the operator of the auction platform. For example, the sharing fraction may depend on:

αE(Rₛ)+(1−α)E(Rₚ)

where α is a mixing parameter between zero and one that may be configured to emphasize seller revenue relative to auction platform revenue, E(Rₛ) is an expected seller revenue derived from a distribution of bids and/or a distribution of reserve prices for a relevant content slot or publisher, and E(Rₚ) is an expected revenue for an auction platform operator derived from distributions of bids and/or reserve prices for a relevant content slot or publisher. For example, the second reserve price may be determined in a manner that attempts to jointly optimize revenues for the seller and the revenues for the operator of the auction platform subject to a minimum cost constraint, as described in Section 3 of The EXAMPLE AUCTION MODELS described below. For example, where the minimum cost is zero, the second reserve price may be determined according to:

$${r}^{α} ( {v}_{0} ) - \frac{1 - F ( {r}^{α} ( {v}_{0} ) )}{f ( {r}^{α} ( {v}_{0} ) )} = {v}_{0} + h ( α ) \cdot \frac{G ( {v}_{0} )}{g ( {v}_{0} )} , \\ for α \leq 0.5 , \\ and$$

$${r}^{α} ( {v}_{0} ) - \frac{1 - F ( {r}^{α} ( {v}_{0} ) )}{f ( {r}^{α} ( {v}_{0} ) )} = {v}_{0} , \\ for α > 0.5$$

where r^{α}(v₀) is the second reserve price, v₀ is the reserve price received from a seller, F( ) is an estimated cumulative distribution of bids received from a buyer (e.g., based on a histogram of past bids for related past content inventory units), f( ) is an estimated probability mass function for bids received from a buyer (e.g., based on a histogram of past bids for related past content inventory units), G( ) is an estimated cumulative distribution of reserve prices received from a seller (e.g., based on a histogram of past reserve prices for related past content inventory units), g( ) is an estimated probability mass function for reserve prices received from a seller (e.g., based on a histogram of past reserve prices for related past content inventory units), and h(α) is defined as:

$$h ( α ) = \{ \begin{matrix}\frac{1 - 2 \cdot α}{1 - α} & if α \leq \frac{1}{2} \\ 0 & if α > \frac{1}{2} .\end{matrix}$$

In some implementations, these equations may be solved using numerical methods to determine a second reserve price, r^{α}(v₀).

For example, the second reserve price may be determined 308 by the content inventory unit allocation module 270 of the auction platform 220.

One or more bids for the content inventory unit may be received 310 from prospective buyers (e.g., advertiser 231 or demand side platform 241). In some implementations, prospective buyers submit bids in response to auction announcement message from the auction platform 220. In some implementations, the auction announcement message includes an indication of the second reserve price. For example, the bids may be received 310 through a network interface of the auction platform 220.

One or more of the received bids may be compared 312 to the second reserve price. For example, the highest bid may be compared to the second reserve price to determine whether the content inventory unit will be allocated to a buyer by the auction platform. In some implementations, the second highest bid is compared to the second reserve price to determine the price that will be paid by the winning bidder, e.g., the buyer that submitted the highest bid. For example, the second reserve price may be compared 312 to one or more bids by the content inventory unit allocation module 270 of the auction platform 220.

If the winning bid is greater than the second reserve price 314, then the content inventory unit is allocated 316 to the buyer that submitted the winning bid. A content item (e.g., an advertisement) from the buyer (e.g., advertiser 231) or a subsequent purchaser will be served in the content inventory unit and, in exchange, the buyer will pay a price that may depend on the bids and/or the second reserve price. For example, the price paid by the buyer may be the maximum of the second highest bid and the second reserve price. Data reflecting the allocation of the content inventory unit to the buyer and the price may be generated and stored in a data storage device. For example, the content inventory unit may be allocated 316 to a buyer by the content inventory unit allocation module 270 of the auction platform 220.

The payment to the seller (e.g., the publisher) that will result from the allocation is also determined 318. The payment to the seller may be determined based on the price paid by the buyer and the sharing fraction. For example, the payment to the seller may be determined as the product of the sharing faction and the buyer's price. The amount of revenue retained by the operator of the auction platform may also be determined. For example the operator of the auction platform may receive the difference between the buyer's price and the payment to the seller as revenue. For example, the payment to the seller may be determined 318 by the content inventory unit allocation module 270 of the auction platform 220.

Data reflecting the allocation of the content inventory unit to the buyer may be transmitted 320. For example the data reflecting the allocation may be transmitted to the buyer (e.g., advertiser 231), the publisher (e.g., publisher 210 and/or webserver 116), and/or a user device (e.g., user device 102 running web browser 112). The data reflecting the allocation may include information identifying the buyer and the content inventory unit. In some implementations, the data reflecting the allocation may also include the price paid by the buyer, the revenue received by the seller, characteristics of the content inventory unit, and/or a content item that will be presented in the content inventory unit as a result of the allocation. In some implementations, information reflecting a content item supplied by the buyer is transmitted to a user device. In some implementations, the content item may be transmitted to the publisher who then relays the content to a user device. In some implementations, the publisher may only receive and relay a pointer to the content item, such as an address for the content item stored on a remote server run by the advertiser or another entity. In some implementations, an external device storing the content item may independently establish a communication with the user's access device based upon information supplied by the publisher with the description of the content inventory unit. Data reflecting the allocation of the content inventory unit may be transmitted in one or more messages over a network (e.g., network 107). For example, data reflecting the identification of the content inventory unit and the price to be paid by the buyer may be transmitted in a first message to the buyer, while data reflecting the revenues paid to the seller may be transmitted to the seller. For example, data reflecting the allocation of the content inventory unit to the buyer may be transmitted 320 through a network interface of the auction platform 220.

If the winning bid is less than the second reserve price 314, then the content inventory unit is not allocated to a buyer. Equivalently, the content inventory unit is allocated back to the seller (e.g., publisher 210). This result may be reflected in data transmitted by auction platform through a network interface to inform the seller and/or any potential buyers that submitted bids.

FIG. 4 is a flowchart of an example process 400 for setting a constant sharing fraction for a publisher or content slot based on data corresponding to past content inventory unit allocations. In some implementations, this process 400 may be executed periodically to update the constant sharing fraction for a particular publisher or content slot. For example process 400 may be performed once per day or once per week. The process 400 may also be started 402 upon the occurrence of some other event, such as initiation by an administrator of the content inventory unit allocation module 270. In some implementations, the implicated constant sharing fraction may be updated every time a new content inventory unit allocation transaction record is received so that the constant sharing fraction is always current. Generally, a system making less frequent updates may be more computationally efficient, so there may be a tradeoff between using the most current and accurate revenue estimates and reduced complexity associated with a lower frequency of updates. For example, the process 400 may be performed by the content inventory unit allocation module 270.

Operations of the process 400 may include obtaining 406 revenue data for a relevant publisher or content slot. In some implementations, data related for revenues for all content slots provided by a publisher are obtained and included in the revenue data. In some implementations, revenue data used is limited to revenue data for a single content slot, where the constant sharing fraction will be applied to new content inventory units in that content slot. As discussed above, revenue data may include, e.g., bids received, reserve prices declared, prices paid by auction winners, and/or revenues paid to sellers for past content inventory unit for a relevant publisher or content slot. In some implementations, revenue data for an auction is ignored or removed, where all bids received by an auction platform (e.g., auction platform 220) conducting the auction were less than the reserve price for the content inventory unit being auctioned. In some implementations, the prices paid by auction winners are used for content inventory units that were successfully allocated by the auction platform and the declared reserve prices are used for content inventory units that were auctioned but not successfully allocated by an auction platform.

In some implementations, the constant sharing fraction is determined based on data for only certain types of content inventory units. For example, a filter may be applied to track revenue for content inventory units occurring in certain portions of a publisher's website or at certain times of day, while disregarding data for other types of content inventory units. In some implementations, the revenue data is obtained 406 by reading stored content inventory unit allocation records from a data storage device (e.g., memory 520 or data storage device 530). In some implementations, the revenue data is obtained 406 by receiving the revenue data from a remote server. For example, a content inventory unit allocation module 270 may obtain 406 the revenue data.

A parameter (e.g., an exponent) for a power law distribution may be determined 410 based on the revenue data. Various techniques may be applied to estimate one or more parameters of a power law distribution that best fits the empirical distribution of revenues represented in the revenue data. For example, a maximum likelihood method may be used to fit a power law distribution to the revenue data and determine the corresponding exponent for the power law distribution. In some implementations, a Kolmogorov-Smirnov estimation method may be used to fit a power law distribution to the revenue data and determine the corresponding exponent for the power law distribution. For example, the content inventory unit allocation module 270 may determine 410 a parameter for a power law distribution based on the revenue data.

The constant sharing fraction may be determined 412 based on one or more parameters of the power law distribution. For example, the constant sharing function may be determined according to:

λ=k/(k+1)

where λ is the constant sharing fraction and k is an exponent for the power law distribution determined based revenue data. For example, the content inventory unit allocation module 270 may determine 410 the constant sharing fraction. The process 400 may then return 416 the constant sharing function for use in the allocation of new content inventory units and terminate.

FIG. 5 is block diagram of an example computer system 500 that can be used to allocate remnant content inventory units. The system 500 includes a processor 510, a memory 520, a storage device 530, and an input/output device 540. Each of the components 510, 520, 530, and 540 can be interconnected, for example, using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 can include, for example, a hard disk device, an optical disk device, or some other large capacity storage device.

The input/output device 540 provides input/output operations for the system 500. In one implementation, the input/output device 540 can include one or more of a network interface devices, e.g., an Ethernet card, a serial communication device, e.g., an RS-232 port, and/or a wireless interface device, e.g., and 802.11 card. In another implementation, the input/output device can include driver devices configured to receive input data and send output data to other input/output devices, e.g., keyboard, printer and display devices 560.

The web server, advertisement server, and content inventory unit allocation module can be realized by instructions that upon execution cause one or more processing devices to carry out the processes and functions described above. Such instructions can comprise, for example, interpreted instructions, such as script instructions, e.g., JavaScript or ECMAScript instructions, or executable code, or other instructions stored in a computer readable medium. The web server and advertisement server can be distributively implemented over a network, such as a server farm, or can be implemented in a single computer device.

Although an example processing system has been described in FIG. 5, implementations of the subject matter and the functional operations described in this specification can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible program carrier, for example a computer-readable medium, for execution by, or to control the operation of, a processing system. The computer readable medium can be a machine readable storage device, a machine readable storage substrate, a memory device, or a combination of one or more of them.

The term “processing system” encompasses all apparatus, devices, and machines for processing data, including by way of example a programmable processor, a computer, or multiple processors or computers. The processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD ROM disks. The processor and the memory can be supplemented by, or incorporated in, special purpose logic circuitry.

Implementations of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client server relationship to each other.

### EXAMPLE AUCTION MODELS

We consider the problem of a platform populated by N buyers indexed by i=1, . . . N and one seller (whose index is 0). The seller can obtain a price ν₀ for his good by trading it outside of the platform. The value of ν₀ is private information of the seller. From the perspective of the platform, ν₀ is a draw from the distribution G with support [a, b].

Each buyer i has a valuation νᵢ for the good offered by the seller. The valuation of each buyer is his private information. From the perspective of the platform, the valuation of each buyer is an independent draw from the distribution F with support [a, b].

Denote v≡(ν₀, ν₁, . . . , ν_{N}) the profile of the seller's and all buyer's types. Following the Revelation Principle, we will confine attention to truthful direct-revelation mechanisms. A direct-revelation mechanism consists of (i) an allocation rule {qᵢ(v)}_{i=0, 1, . . . , N} that maps v into probabilities that each agent is assigned the good (q₀(v) stands for the probability that the seller keeps the good), and (ii) a payment rule {p₁(v)}_{i=0, 1, . . . N} that maps v into payments for each buyer i and the seller.

An allocation is feasible is Σᵢ₌₀^{N} qᵢ(v)=1 for all v.

Denote by Qᵢ(νᵢ)=Eᵥ₋₁ [qᵢ(v)] the interim probability that agent i is assigned the good and by Pᵢ(νᵢ)≡Eᵥ₋ᵢ [pᵢ(v)] the interim payment of each agent i.

A mechanism is incentive compatible and individually rational if and only if the all iε{0, 1, . . . , N}

Uᵢ(ν)=Qᵢ(ν)·ν−Pᵢ(ν)≧max{Qᵢ(\hat{ν})·ν−Pᵢ(\hat{ν}),0}.

for all ν, \hat{ν}ε[a,b].

It is standard to show that a mechanism is incentive compatible and individually rational if and only if Qᵢ(·) is weakly increasing and

Uᵢ(ν)=Uᵢ(a)+∫_{b}^{a} Qᵢ(\hat{ν})d\hat{ν}=Uᵢ(b)−∫ₐ^{b} Qᵢ(\hat{ν})d\hat{ν}≧0.

The platform's expected profits are then

$${\sum }_{i = 1}^{N} {\int }_{a}^{b} {P}_{i} ( v ) d F ( v ) + {\int }_{a}^{b} {P}_{0} ( v ) d G ( v ) .$$

### Section 1: A Platform-Optimal Mechanism

### Proposition 1

### Platform-Optimal Direct-Revelation Mechanism

The platform-optimal direct-revelation mechanism sets qᵢ(νᵢ)=1 if and only if

$${v}_{i} - \frac{1 - F ( {v}_{i} )}{f ( {v}_{i} )} - {v}_{0} - \frac{G ( {v}_{0} )}{g ( {v}_{0} )} = {max}_{j ∈ \{ 1 , … , N \}} \{ {v}_{j} - \frac{1 - F ( {v}_{j} )}{f ( {v}_{j} )} - {v}_{0} - \frac{G ( {v}_{0} )}{g ( {v}_{0} )} , 0 \} ,$$

and sets q₀(ν)=1 if there is no jε{1, . . . , N} that satisfies the equation above.

Proof. The platform's profits can be rewritten as

$${\int }_{a}^{b} … {\int }_{a}^{b} \{ {\sum }_{i = 1}^{N} {q}_{i} ( v ) \cdot ( {v}_{i} - \frac{1 - F ( {v}_{i} )}{f ( {v}_{i} )} - {v}_{0} - \frac{G ( {v}_{0} )}{g ( {v}_{0} )} ) \} \cdot ( {\prod }_{i = 1}^{N} f ( {v}_{i} ) ) \cdot g ( {v}_{0} ) ( {\prod }_{i = 0}^{N} {dv}_{i} ) - {U}_{i} ( a ) + [ b - {U}_{0} ( b ) ] .$$

It is immediate that at the optimum Uᵢ(a)=0 and U₀(b)=b. Maximizing the integral above pointwise leads to the following bang-bang solution qᵢ(νᵢ)=1 for iε{1, . . . , N} if

$${v}_{i} - \frac{1 - F ( {v}_{i} )}{f ( {v}_{i} )} - {v}_{0} - \frac{G ( {v}_{0} )}{g ( {v}_{0} )} = {max}_{j ∈ \{ 1 , … , N \}} \{ {v}_{j} - \frac{1 - F ( {v}_{j} )}{f ( {v}_{j} )} - {v}_{0} - \frac{G ( {v}_{0} )}{g ( {v}_{0} )} , 0 \} ,$$

and q₀(ν)=1 if there is no jε{1, . . . , N} that satisfies the equality above. Q.E.D.

One possible indirect implementation of the above mechanism is as follows:

### Proposition 2

### Platform-Optimal Direct Mechanism

The following trading procedure maximizes the platform's profits.

1. The seller is asked to report his opportunity cost ν₀.

2. The platform runs a second-price auction with reserve price r(ν₀).

3. The platform gives to the seller a fraction λ(ν₀) of the proceeds of the auction, where the sharing rule λ(·) satisfies

$$λ ( {v}_{0} ) \cdot {\int }_{r ( {v}_{0} )}^{b} \{ v - \frac{1 - F ( v )}{f ( v )} \} f ( v ) \cdot {F}^{N - 1} ( v ) d v = 1 - {F}^{N} ( r ( {v}_{0} ) ) + {\int }_{{v}_{0}}^{b} ( 1 - {F}^{N} ( r ( \hat{v} ) ) d \hat{v} .$$

The one caveat with the above indirect mechanism suggested above is that the sharing rule λ(ν₀) depends on ν₀. Next, we discuss another type of indirect implementation which is cleaner and would result in a mechanism which might be easier to implement.

### Indirect Implement Through Constant Cost Sharing

Here we discuss how to indirectly implement the platform-optimal direct-revelation mechanism using a sharing scheme which does not depend on the ν₀ but only the distribution of the opportunity costs. First, let's define the function r(·) such that

$$r ( {v}_{n} ) - \frac{1 - F ( r ( {v}_{0} ) )}{f ( r ( {v}_{0} ) )} = {v}_{0} + \frac{G ( {v}_{0} )}{g ( {v}_{0} )} .$$

We will now discuss how to indirectly implement the platform-optimal direct-revelation mechanism. To this end, let's define the function r(·) such that

$$r ( {v}_{0} ) - \frac{1 - F ( r ( {v}_{0} ) )}{f ( r ( {v}_{0} ) )} = {v}_{0} + \frac{C ( {v}_{0} )}{g ( {v}_{0} )} ,$$

and the inverse ν₀(r) according to

$$r - \frac{1 - F ( r )}{f ( r )} = {v}_{0} ( r ) + \frac{G ( {v}_{0} ( r ) )}{g ( {v}_{0} ( r ) )} .$$

Denote by R(r,N) the expected revenue of a second-price auction with N bidders and reserve price r:

$$R ( r , N ) ≡ N \cdot {\int }_{r}^{b} \{ v - \frac{1 \vert - F ( v )}{f ( v )} \} f ( v ) \cdot {F}^{N - 1} ( v ) d v .$$

One natural way of implementing the platform-optimal mechanism described above is through sharing schemes. Such schemes work as follows:
1. The seller is asked to report a reserve price \hat{r}.
2. The platform rate a second-price auction with reserve price \hat{r}.
3. The platform gives to the seller a fraction θ(\hat{r}) of the proceeds of the auction.

The next proposition shows how to compute the sharing rule θ(·).

### Proposition 3

### Platform-Optimal Sharing Scheme

The platform-optimal direct revelation mechanism can be implemented by a sharing scheme which sharing rule θ(·) is given by

$$θ ( \dot{r} ) = \frac{b - {v}_{0} ( \hat{r} ) - {F}^{N} ( \hat{r} ) - {\int }_{∞ ( \hat{v} )}^{t} {P}^{N} ( r ( \hat{v} ) ) d \hat{v}}{R ( \hat{r} , N )} . \qquad ( 1 )$$

A special class of sharing schemes is that of constant sharing schemes, where θ(·) is constant across all possible reserve price. The next proposition provides a necessary and sufficient condition for constant sharing schemes to be optimal.

### Proposition 4

### Optimality of Constant Sharing Schemes

A constant sharing scheme indirectly implements the platform-optimal mechanism if and only if

$$G ( {v}_{0} ) = {( \frac{{v}_{0}}{b} )}^{k} ,$$

where k>0. In this case

$$θ ( r ) = \frac{k}{k + 1}$$

for all r.

The result above can be understood in the light of monopsonistic price theory. Intuitively, polynomial distribution functions have a constant price elasticity of supply (which measures how many more percentage points of inventory sellers are willing to offer for one percentage increase in expected revenue). Namely a distribution of the form

$$G ( {v}_{0} ) = {( \frac{{v}_{0}}{b} )}^{k}$$

have a price elasticity of supply equal to k for all opportunity costs ν₀. As it turns out, constant sharing schemes are optimal provided that the price elasticity of supply is constant.

As the price elasticity increases, the revenue fraction of the seller goes up. Intuitively, as the distribution of the seller's opportunity costs become concentrated on high values, the platform has to increase the seller's revenue share to make sure that the seller will be willing to participate in the trading mechanism with high enough probability.

The example below confirms the result above for the case of a uniform distribution.

### Example 1

Assume that F=G˜U[0, b], in which case

$$r ( {v}_{6} ) = \frac{b}{2} + {v}_{0}$$

$$and$$

$${r}^{- 2} ( \hat{r} ) = \hat{r} - \frac{b}{2}$$

### Then:

$$\begin{matrix}λ ( \dot{r} ) \cdot N \cdot {\int }_{\hat{r}}^{b} \{ v - \frac{1 - F ( v )}{f ( v )} \} f ( v ) \cdot {F}^{N - 1} ( v ) d v = λ ( \hat{r} ) \cdot N \cdot {\int }_{\hat{r}}^{b} [ 2 v - b ) \cdot \frac{1}{b} \cdot {( \frac{v}{b} )}^{N - 1} d v \\ = λ ( \hat{r} ) \cdot \frac{N}{{b}^{N}} \cdot {\int }_{\hat{r}}^{b} \{ 2 {v}^{N} - {bv}^{N - 1} \} d v λ ( \hat{r} ) \cdot \frac{N}{{b}^{N}} \cdot {[ \frac{2 {v}^{N + 1}}{N + 1} - \frac{{bv}^{N}}{N} ]}_{\hat{r}}^{b} \\ = λ ( \hat{r} ) \cdot \frac{N}{{b}^{N}} \cdot [ {b}^{N + 1} \cdot \frac{N - 1}{N ( N + 1 )} - {\hat{r}}^{N + 1} \cdot \frac{2}{N + 1} + b {\hat{r}}^{N} \cdot \frac{1}{N} ] .\end{matrix} \qquad ( 2 )$$

In turn,

$$\begin{matrix}b - {r}^{- 1} ( \hat{r} ) \cdot {F}^{N} ( \hat{r} ) - {\int }_{{r}^{- 1} ( \hat{r} )}^{b} {F}^{N} ( r ( \dot{v} ) ) d \dot{v} = b - ( \hat{r} - \frac{b}{2} ) \cdot {( \frac{\hat{r}}{b} )}^{N} - {\int }_{i = \frac{k}{2}}^{\frac{i}{2}} {( \frac{\frac{b}{2} + {\overline{v}}_{0}}{b} )}^{N} d {\overline{v}}_{0} - {\int }_{\frac{b}{2}}^{b} d \hat{v} \\ = \frac{b}{2} - ( \hat{r} - \frac{b}{2} ) \cdot {( \frac{\hat{r}}{b} )}^{N} - {\frac{1}{{b}^{N}} [ {( \frac{b}{2} + {\hat{v}}_{0} )}^{N + 1} \cdot \frac{1}{N + 1} ]}_{\hat{r} = \frac{b}{2}}^{\frac{b}{2}} \\ = \frac{b}{2} + \frac{{\hat{r}}^{N + 1}}{{b}^{N}} ( 1 - \frac{N}{N + 1} ) + b \frac{{\hat{r}}^{N}}{{b}^{N}} \cdot \frac{1}{2} - \frac{{b}^{N + 1}}{{b}^{N}} \frac{1}{N + 1} \\ = \frac{N}{{b}^{N}} \cdot [ {b}^{N + 1} \cdot ( \frac{1}{2 N} - \frac{1}{N ( N + 1 )} ) - {\hat{r}}^{N + 1} \frac{1}{N + 1} + b {\hat{r}}^{N} \cdot \frac{1}{2 N} ] \\ = \frac{N}{{b}^{N}} \cdot [ {b}^{N + 1} \cdot \frac{N - 1}{2 N ( N + 1 )} - {\hat{r}}^{N + 1} \frac{1}{N + 1} + b {\hat{r}}^{N} \cdot \frac{1}{2 N} ] .\end{matrix} \qquad ( 3 )$$

Comparing (2) and (3) leads to

$$λ ( \hat{r} ) = \frac{1}{2} for all \hat{r} ∈ [ \frac{b}{2} , b ] .$$

Before stating the seller-optimal and hybrid mechanisms, we present a proof of Proposition 4.

Proof of Proposition 4 The expression (1) can be rewritten as

θ(\hat{r})·R(\hat{r},N)=b−ν₀(\hat{r})·F^{N}(\hat{r})−∫_{ν}_{₀}_{(\hat{r}})^{b} F^{N}(r(\hat{ν}))d\hat{ν}.

Differentiating with respect to \hat{r} leads to the following linear differential equation.

$${θ}^{′} ( \hat{r} ) \cdot R ( \hat{r} , N ) + θ ( \hat{r} ) \cdot \frac{\partial R}{\partial \hat{r}} \cdot \frac{\partial R}{\partial \hat{r}} ( \dot{r} , N ) = - {v}_{0} ( \hat{r} ) \cdot N \cdot {F}^{N - 1} ( \hat{r} ) \cdot f ( \hat{r} ) .$$

Therefore (θ′(\hat{r})=0 for all r if and only if

$$θ ( \hat{r} ) \cdot \frac{\partial R}{\partial \hat{r}} ( \hat{r} , N ) = - {v}_{0} ( \hat{r} ) \cdot N \cdot {F}^{N - 1} ( \hat{r} ) \cdot f ( \hat{r} ) .$$

Note that

$$\begin{matrix}\frac{\partial R}{\partial \hat{r}} ( \hat{r} , N ) = - N \cdot \{ r - \frac{1 - F ( r )}{f ( r )} \} f ( r ) \cdot {F}^{N - 1} ( r ) \\ = - N \cdot \{ {v}_{0} ( v ) + \frac{G ( {v}_{0} ( r ) )}{g ( {v}_{0} ( r ) )} \} f ( r ) \cdot {F}^{N - 1} ( r ) .\end{matrix}$$

Therefore (θ′(\hat{r})=0 for all r if and only if

$$( {v}_{0} ( r ) + \frac{G ( {v}_{0} ( r ) )}{g ( {v}_{0} ( r ) )} ) θ ( \hat{r} ) = {v}_{0} ( \hat{r} ) ,$$

which can be rewritten as

$$\frac{θ ( \hat{r} )}{1 - θ ( \hat{r} )} = \frac{{v}_{0} ( \hat{r} ) \cdot g ( {v}_{0} ( r ) )}{G ( {v}_{0} ( r ) )} .$$

The function ν₀(r) is strictly increasing in r. Therefore, the expression above is constant for every r if and only if

$$\frac{xg ( x )}{G ( x )}$$

is constant, what leads to

$$G ( {v}_{0} ) = {( \frac{{v}_{0}}{b} )}^{k} .$$

Finally, note that if

$$G ( {v}_{0} ) = {( \frac{{v}_{0}}{b} )}^{k} ,$$

then

$$\frac{θ ( \hat{r} )}{1 - θ ( \hat{r} )} = k ,$$

what leads to

$$θ ( r ) = \frac{k}{k + 1}$$

for all r. Q.E.D.

### Section 2: A Seller-Optimal Mechanism

Motivated by recent developments in ad exchanges, we will now derive the trading mechanism that maximizes the seller's expected payoff. In order to operate, the platform has to achieve some minimal profit level K. The designer's problem is then to choose {qᵢ(v),pᵢ(v)}_{i=0, 1, . . . , N} to

max ∫ₐ^{b} U₀(ν)dG(ν), (4)

subject to IR, IC, the feasibility constraint, and

$${\sum }_{i = 1}^{N} {\int }_{a}^{b} {P}_{i} ( v ) d F ( v ) + {\int }_{a}^{b} {P}_{0} ( v ) d G ( v ) \geq K .$$

### Proposition 5

### Seller-Optimal Direct-Revelation Mechanism

The seller-optimal direct-revelation mechanism sets qᵢ(νᵢ)=1 if and only if

$${v}_{i} - \frac{1 - F ( {v}_{i} )}{f ( {v}_{i} )} - {v}_{0} - λ ( K ) \cdot \frac{G ( {v}_{0} )}{g ( {v}_{0} )} = {max}_{j ∈ \{ 1 , … , N \}} \{ {v}_{j} - \frac{1 - F ( {v}_{j} )}{f ( {v}_{j} )} - {v}_{0} - λ ( K ) \cdot \frac{G ( {v}_{0} )}{g ( {v}_{0} )} , 0 \} ,$$

and sets q₀(ν)=1 (if there is no jε{1, . . . , N} that satisfies the equality above. The function λ:[0, K*]→[0,1] is strictly increasing in K, and satisfies λ(0)=0 and λ(K*)=1, where

$${K}^{*} = {\int }_{a}^{b} {\int }_{r ( {v}_{0} )}^{b} \{ v - \frac{1 - F ( v )}{f ( v )} - {v}_{0} - \frac{G ( {v}_{0} )}{g ( {v}_{0} )} \} f ( v ) \cdot {F}^{N - 1} ( v ) g ( {v}_{0} ) d v d {v}_{0} , \\ with \\ r ( {v}_{0} ) - \frac{1 - F ( r ( {v}_{0} ) )}{f ( r ( {v}_{0} ) )} = {v}_{0} + \frac{G ( {v}_{0} )}{g ( {v}_{0} )} . \\ For each K , λ ( K ) solves \\ K = {\int }_{a}^{b} {\int }_{s ( {v}_{0} , λ ( K ) )}^{b} \{ v - \frac{1 - F ( v )}{f ( v )} - {v}_{0} - λ ( K ) \cdot \frac{G ( {v}_{0} )}{g ( {v}_{0} )} \} f ( v ) \cdot {F}^{N - 1} ( v ) g ( {v}_{0} ) d v d {v}_{0} , \\ with \\ s ( {v}_{0} , λ ) - \frac{1 - F ( s ( {v}_{0} , λ ) )}{f ( s ( {v}_{0} , λ ) )} = {v}_{0} + λ \cdot \frac{G ( {v}_{0} )}{g ( {v}_{0} )} . \qquad ( 5 )$$

Proof. The platform's profits can be rewritten as

$${\int }_{a}^{b} … {\int }_{a}^{b} \{ {\sum }_{i = 1}^{N} {q}_{i} ( v ) \cdot ( {v}_{i} - \frac{1 - F ( {v}_{i} )}{f ( {v}_{i} )} - {v}_{0} - \frac{G ( {v}_{0} )}{g ( {v}_{0} )} ) \} \cdot ( {\prod }_{i = 1}^{N} f ( {v}_{i} ) ) \cdot g ( {v}_{0} ) ( {\prod }_{i = 0}^{N} {dv}_{i} ) - {U}_{i} ( α ) + [ b - {U}_{0} ( b ) ] .$$

In turn, the platform's objective rewrites

$${U}_{0} ( b ) - b + 𝔼 ( {\overline{v}}_{0} ) - {\int }_{a}^{b} … {\int }_{a}^{b} \{ {\sum }_{i = 1}^{N} {q}_{i} ( v ) \cdot \frac{G ( {v}_{0} )}{g ( {v}_{0} )} \} \cdot ( {\prod }_{i = 1}^{N} f ( {v}_{i} ) ) \cdot g ( {v}_{0} ) ( {\prod }_{i = 0}^{N} {dv}_{i} )$$

Expressing the platform's constrained maximization problem in Lagrangean form leads to

$$ℒ = {\int }_{a}^{b} … {\int }_{a}^{b} \{ {\sum }_{i = 1}^{N} {q}_{i} ( v ) \cdot ( μ \cdot {v}_{i} - μ \cdot \frac{1 - F ( {v}_{i} )}{f ( {v}_{i} )} - μ \cdot {v}_{0} - ( 1 + μ ) \cdot \frac{G ( {v}_{0} )}{g ( {v}_{0} )} ) \} \cdot ( {\prod }_{i = 1}^{N} f ( {v}_{i} ) ) \cdot g ( {v}_{0} ) ( {\prod }_{i = 0}^{N} {dv}_{i} )$$

where μ>0. It is immediate that at the optimum Uᵢ(a)=0 and U₀(b). Maximizing the integral above pointwise leads to the following bang-bang solution: qᵢ(νᵢ)=1 for iε{1, . . . , N} if

$$μ \cdot {v}_{i} - μ \cdot \frac{1 - F ( {v}_{i} )}{f ( {v}_{i} )} - ( 1 + μ ) \cdot ( {v}_{0} - \frac{G ( {v}_{0} )}{g ( {v}_{0} )} ) = {max}_{j ∈ \{ 1 , … , N \}} \{ μ \cdot {v}_{j} - μ \cdot \frac{1 - F ( {v}_{j} )}{f ( {v}_{j} )} - ( 1 + μ ) \cdot ( {v}_{0} - \frac{G ( {v}_{0} )}{g ( {v}_{0} )} ) , 0 \} ,$$

and q₀(ν)=1 if there is no jε{1, . . . , N} that satisfies the equality above. Defining

$$λ ≡ \frac{μ}{1 + μ}$$

leads to the statement in the proposition. Finally, since the profit constraint is always binding, the value of λ is given by (5). Q.E.D.

### Proposition 6

### Seller-Optimal Indirect Mechanism

The following trading procedure maximizes the platform's profits.

1. The seller is asked to report his opportunity cost ν₀.

2. The platform runs a second-price auction with reserve price s(ν₀,λ(K)).

3. The platform gives to the seller a fraction λ(ν₀,K) of the process of the auction, where the sharing rule λ(·) satisfies

$$λ ( {v}_{0} , K ) \cdot {\int }_{s ( {v}_{0} , λ ( K ) )}^{b} \{ v - \frac{1 - F ( v )}{f ( v )} \} f ( v ) \cdot {F}^{N - 1} ( v ) d v = 1 - {F}^{N} ( s ( {v}_{0} , λ ( K ) ) ) + {\int }_{{v}_{0}}^{b} ( 1 - {F}^{N} ( s ( \hat{v} , λ ( K ) ) ) d \hat{v} .$$

### Section 3: Maximizing a Convex Combination of Platform Profits and Seller Payoffs

Competition among ad exchanges is likely to favor auction rules that secure high payoffs to sellers. Intuitively, competition has the effect of making ad exchange internalize (at least partially) the sellers' payoffs in its objective objective function. Motivated by this observation, we will now derive the trading mechanism that maximizes a convex combination of the seller's expected payoff and the platform's profits. The designer's problem (denoted P^{α}) is then to choose {qᵢ(v),pᵢ(v)}_{i=0, 1, . . . , N} to

P^{α}: max{α·∫ₐ^{b}U₀(ν)dG(ν)+(1−α)·Π}, (2)

subject to IR, IC, the feasibility constraint, and the platform's break-even constraint

Π≧0, (3)

which states that the platform makes non-negative profits. We refer to the mechanism that solves problem P^{α} as the α-optimal mechanism, and denoted it by {qᵢ^{α}(v),pᵢ^{α}(v)}_{i=0, 1, . . . , N}.

### Proposition 1

### The α-Optimal Direct-Revelation Mechanism

Let us choose indexes such that νᵢ=max_{jε(1, . . . , N)} {νⱼ}. The α-optimal direct-revelation mechanism is described below:

1. Let α≦½. Then qᵢ^{α}(νᵢ)=1 if

$${v}_{i} - \frac{1 - F ( {v}_{i} )}{f ( {v}_{i} )} - {v}_{0} - \frac{1 - 2 \cdot α}{1 - α} \cdot \frac{G ( {v}_{0} )}{g ( {v}_{0} )} \geq 0.$$

Otherwise, no sales occur: q₀^{α}(ν)=1.

2. Let α>½. Then qᵢ^{α}(νᵢ)=1 if

$${v}_{i} - \frac{1 - F ( {v}_{i} )}{f ( {v}_{i} )} - {v}_{0} \geq 0.$$

Otherwise, no sales occur: q₀^{α}(ν)=1.

Proof. Applying the envelope formula (1), the platform's profits can be rewritten as

$$Π = {\int }_{{[ a , b ]}^{N + 1}}^{ } \{ {\sum }_{i = 1}^{N} {q}_{i} ( v ) \cdot ( {v}_{i} - \frac{1 - F ( {v}_{i} )}{f ( {v}_{i} )} - {v}_{0} - \frac{G ( {v}_{0} )}{g ( {v}_{0} )} ) \} \cdot {\prod }_{i = 1}^{N} d F ( {v}_{i} ) d G ( {v}_{0} ) - {\sum }_{i = 1}^{N} {U}_{i} ( a ) - {U}_{0} ( b ) .$$

In turn, the seller's payoff can be written as:

$$\begin{matrix}{\int }_{a}^{b} {U}_{0} ( {v}_{0} ) d G ( {v}_{0} ) = {U}_{0} ( b ) - {\int }_{a}^{b} {\int }_{{v}_{0}}^{b} {Q}_{i} ( \hat{v} ) g ( {v}_{0} ) d \hat{v} d {v}_{0} \\ = {U}_{0} ( b ) - {\int }_{a}^{b} G ( {v}_{0} ) \cdot {Q}_{i} ( {v}_{0} ) d {v}_{0} \\ = {U}_{0} ( b ) - {\int }_{a}^{b} G ( {v}_{0} ) \cdot {\int }_{a}^{b} … {\int }_{a}^{b} ( 1 - {\sum }_{i = 1}^{N} {q}_{i} ( v ) ) \\ ( {\prod }_{i = 1}^{N} f ( {v}_{i} ) ) ( {\prod }_{i = 1}^{N} {dv}_{i} ) d {v}_{0} \\ = {U}_{0} ( b ) - b + 𝔼 ( {\tilde{v}}_{0} ) + {\int }_{{[ a , b ]}^{N + 1}}^{ } \{ {\sum }_{i = 1}^{N} {q}_{i} ( v ) \cdot \frac{G ( {v}_{0} )}{g ( {v}_{0} )} \} \cdot \\ {\prod }_{i = 1}^{N} d F ( {v}_{i} ) d G ( {v}_{0} ) .\end{matrix}$$

The platform objective is then

$${\int }_{{[ a , b ]}^{N + 1}}^{ } \{ {\sum }_{i = 1}^{N} {q}_{i} ( v ) \cdot ( ( 1 - α ) \cdot [ {v}_{i} - \frac{1 - F ( {v}_{i} )}{f ( {v}_{i} )} - {v}_{0} ] - ( 1 - 2 α ) \cdot \frac{G ( {v}_{0} )}{g ( {v}_{0} )} ) \} \cdot {\prod }_{i = 1}^{N} d F ( {v}_{i} ) d G ( {v}_{0} ) - ( 1 - α ) \cdot ( {\sum }_{i = 1}^{N} {U}_{i} ( a ) ) + α \cdot ( 𝔼 ( {\overline{v}}_{0} ) - b ) + ( 2 α - 1 ) \cdot {U}_{0} ( b ) . \qquad ( 4 )$$

If α≦½, the platform's objective is decreasing in Uᵢ(a) and U₀(b). This implies that, at the α-optimum, the individual rationality constraints have to bind at for every buyer for type a and every seller of type b: Uᵢ(a)=0 and U₀(b)=b. Maximizing the integral above pointwise leads to the following bang-bang solution: qᵢ(νᵢ)=1 for iε{1, . . . , N} if

$${v}_{i} - \frac{1 - F ( {v}_{i} )}{f ( {v}_{i} )} - {v}_{0} - \frac{1 - 2 \cdot α}{1 - α} \cdot \frac{G ( {v}_{0} )}{g ( {v}_{0} )} = {max}_{j ∈ \{ 1 , … , N \}} \{ {v}_{j} - \frac{1 - F ( {v}_{j} )}{f ( {v}_{j} )} - {v}_{0} - \frac{1 - 2 \cdot α}{1 - α} \cdot \frac{G ( {v}_{0} )}{g ( {v}_{0} )} , 0 \} ,$$

and q₀(ν)=1if there is no jε{1, . . . , N} that satisfies the equality above.

In turn, if α>½, the platform's objective is decreasing in Uᵢ(a) and increasing in U₀(b). This implies that, at the α-optimum, Uᵢ(a)=0 and U₀(b) will be set to satisfy the break-even constraint with equality:

$${U}_{0} ( b ) = {\int }_{{[ a , b ]}^{N + 1}} \{ {\sum }_{i = 1}^{N} {q}_{i} ( v ) \cdot ( {v}_{i} - \frac{1 - F ( {v}_{i} )}{f ( {v}_{i} )} - {v}_{0} - \frac{G ( {v}_{0} )}{g ( {v}_{0} )} ) \} \cdot {\prod }_{i = 1}^{N} d F ( {v}_{i} ) d G ( {v}_{0} ) . \qquad ( 5 )$$

Plugging (5) into the objective (4) leads to

$${\int }_{{[ a , b ]}^{N + 1}}^{ } \{ {\sum }_{i = 1}^{N} {q}_{i} ( v ) \cdot α \cdot [ {v}_{i} - \frac{1 - F ( {v}_{i} )}{f ( {v}_{i} )} - {v}_{0} ] \} \cdot {\prod }_{i = 1}^{N} d F ( {v}_{i} ) d G ( {v}_{0} ) + α \cdot ( 𝔼 ( {\overline{v}}_{0} ) - b ) .$$

Maximizing the integral above pointwise leads to the following bang-bang solution: qᵢ(νᵢ)=1 for iε{1, . . . , N} if

$${v}_{i} - \frac{1 - F ( {v}_{i} )}{f ( {v}_{i} )} - {v}_{0} = {max}_{j ∈ \{ 1 , … , N \}} \{ {v}_{j} - \frac{1 - F ( {v}_{j} )}{f ( {v}_{j} )} - {v}_{0} , 0 \} ,$$

and q₀(ν)=1 if there is no jε{1, . . . , N} that satisfies the equality above.

Because F has an increasing hazard rate and G has a decreasing reverse hazard rate, it follows that qᵢ^{α}(νᵢ, v₋₁) is weakly increasing in νᵢ for every αε[0,1] (i.e., the α-optimal mechanism is implementable). Q.E.D.

### Indirect Implementation: Sharing Rules

Before proceeding, let us define the function

$$h ( α ) = \{ \begin{matrix}\frac{1 - 2 - α}{1 - α} & if α \leq \frac{1}{2} \\ 0 & if α > \frac{1}{2} .\end{matrix}$$

Note that the function h(α) is continuous at α=½.

One natural way to indirectly implement the direct-revelation mechanism above is through sharing rules. They work as follows:

1. The seller is asked to report a reserve price \hat{r}.

2. The platform runs a second-price auction with reserve price \hat{r}.

3. The platform gives to the seller a fraction θ^{p}(\hat{r}) of the proceeds of the auction.

The next proposition shows how to define the sharing rule θ^{p}(·) that implements the optimal mechanism identified in Proposition 1. To this end, let us define the function r^{α}(·) such that

$${r}^{α} ( {v}_{0} ) - \frac{1 - F ( {r}^{α} ( {v}_{0} ) )}{f ( {r}^{α} ( {v}_{0} ) )} = {v}_{0} + h ( α ) \cdot \frac{G ( {v}_{0} )}{g ( {v}_{0} )} ,$$

and the inverse ν₀^{a}(r) according to

$$r - \frac{1 - F ( r )}{f ( r )} = {v}_{0}^{α} ( r ) + h ( α ) \cdot \frac{G ( {v}_{0}^{α} ( r ) )}{g ( {v}_{0}^{α} ( r ) )} .$$

Define the minimum reserve price r according to

$$\underline{r} - \frac{1 - F ( \underline{r} )}{f ( \underline{r} )} = a$$

(if this equation does not admit is solution in [a,b], set r=a).

Denote by R(r,N) the expected revenue of a second-price auction with N bidders and reserve price r:

$$R ( r , N ) ≡ N \cdot {\int }_{r}^{b} \{ v - \frac{1 - F ( v )}{f ( v )} \} f ( v ) \cdot {F}^{N - 1} ( v ) d v .$$

### Proposition 2

### Platform-Optimal Sharing Scheme

The α-optimal direct-revelation mechanism can be implemented by a sharing scheme which sharing rule θ^{α}(·) is given by

$${θ}^{α} ( \hat{r} ) = \frac{b - {v}_{0}^{α} ( \hat{r} ) \cdot {F}^{N} ( \hat{r} ) - {\int }_{{v}_{0}^{α} ( \hat{r} )}^{b} {F}^{N} ( r ( \hat{v} ) ) d \hat{v}}{R ( \hat{r} , N )} \\ for \\ \hat{r} ∈ [ \underline{r} , b ] \qquad ( 6 )$$

and θ^{α}(\hat{r})=0 for \hat{r}<r.

Proof. By the Envelope formula (1), the expected payment to a seller with value λ₀ under the α-optimal mechanism is given by

b−ν₀·F^{N}(r^{α}(ν₀))−∫_{ν}_{₀}^{b}F^{N}(r^{α(\hat{ν}))d\hat{ν}.} (7)

Rather than asking sellers to report ν₀, the sharing mechanism considered here requires that sellers report some reserve price r. Let us posit that the seller' equilibrium reserve price strategy is given by r^{α}(ν₀). We will derive the expected payments induced by this strategy, and then argue that submitting reserve prices according to r^{α} (ν₀) is profit-maximizing for the seller.

Because F has an increasing hazard rate, G has a decreasing reverse hazard rate, and h(·)≧0, we know that the function r^{α}) (ν₀) is strictly increasing. Therefore we can rewrite the expected payments of a seller with value ν₀ in terms of his submitted reserve price \hat{r}−r^{α}(ν₀):

b−ν₀^{α}(\hat{r})·F^{N}(\hat{r})−∫_{ν}_{₀}_{^{α}}_{(\hat{r})}^{b}F^{N}(r^{α}(\hat{ν}))d\hat{ν}.

We will define the sharing θ^{p}(·) such that the expected revenue that the seller obtains from the second-price auction run at stage 2 equals the expected payments implied by incentive compatibility. This is equivalent to

θ^{α}(\hat{r})·R(\hat{r},N)=b−ν₀^{α}(\hat{r})·F^{N}(\hat{r})−∫_{ν}_{₀}_{^{α}}_{(\hat{r})}F^{N}(r^{α}(\hat{ν}))d\hat{ν}.

After rearranging, we get the formula (6).

We will now argue that submitting reserve prices according top r^{α}(ν₀) is profit-maximizing for the seller. To see why, notice that the seller problem can be written as

$$\text{?} {v}_{0} \cdot {F}^{N} ( \hat{r} ) + {θ}^{α} ( \hat{r} ) \cdot R ( \hat{r} , N ) . \\ \text{?} \text{indicates text missing or illegible when filed}$$

By construction, the selection r^{α}(ν₀) satisfies the envelope formula (1). Because the seller's objective satisfies strictly increasing differences, we can use the Constraint Simplification Theorem (Milgrom (2004), page 105) to conclude that r^{α}(ν₀) best responds all bids in the range [r,b]. Because it is clearly suboptimal to submit a reserve price lower than r (since θ^{α}(\hat{r})=0 for \hat{r}<r) or greater than b, we conclude that submitting reserve prices according to r^{α}(ν₀) is profit-maximizing for the seller. Q.E.D.

A special class of sharing schemes is that of constant sharing schemes, where θ^{p}(·) is constant across all possible reserve prices. The next proposition provides a necessary and sufficient condition for constant sharing schemes to be optimal.

### Proposition 3

### α-Optimal Constant Sharing Schemes

A constant sharing scheme indirectly implements the platform-optimal mechanism if and only if

$$G ( {v}_{0} ) = {( \frac{{v}_{0}}{b} )}^{k} ,$$

where k>0. In this case,

$${θ}^{α} ( r ) = \frac{k}{k + h ( α )}$$

$$for$$

$$all$$

$$r ∈ [ \underline{r} , b ]$$

and θ^{α}(\hat{r})=0 for \hat{r}<r.

Proof of Proposition 3. The expression (6) can be rewritten as

θ^{α}(r)·R(r,N)=b−ν₀^{α}(r)·F^{N}(r)−∫_{ν}_{₀}_{^{α}}₍ᵣ₎^{b}F_{N}(r^{α}(\hat{ν}))d\hat{ν}.

Differentiating with respect to r leads to the following linear differential equation.

$${( {θ}^{α} )}^{′} ( r ) \cdot R ( r , N ) + {θ}^{α} ( r ) \cdot \frac{\partial R}{\partial r} ( r , N ) = - {v}_{0}^{α} ( r ) \cdot N \cdot {F}^{N - 1} ( r ) \cdot f ( r ) .$$

Therefore, (θ^{α})′(r)=0 for all r if and only if

$${θ}^{α} ( r ) \cdot \frac{\partial R}{\partial r} ( r , N ) = - {v}_{0}^{α} ( r ) \cdot N \cdot {F}^{N - 1} ( r ) \cdot f ( r ) .$$

Note that

$$\begin{matrix}\frac{\partial R}{\partial r} ( r , N ) = - N \cdot \{ r - \frac{1 - F ( r )}{f ( r )} \} f ( r ) \cdot {F}^{N - 1} \\ = - N \cdot \{ {v}_{0}^{α} ( r ) + h ( α ) \cdot \frac{G ( {v}_{0}^{α} ( r ) )}{g ( {v}_{0}^{α} ( r ) )} \} f ( r ) \cdot {F}^{N - 1} ( r ) .\end{matrix}$$

Therefore, (θ^{α})′(r)=0 for all r if and only if

$$( {v}_{0}^{α} ( r ) + h ( α ) \cdot \frac{G ( {v}_{0}^{α} ( r ) )}{g ( {v}_{0}^{α} ( r ) )} ) {θ}^{α} ( r ) = {v}_{0}^{α} ( r ) ,$$

which can be rewritten as

$$\frac{1 - {θ}^{α} ( r )}{{θ}^{α} ( r )} = h ( α ) \cdot \frac{G ( {v}_{0}^{α} ( r ) )}{{v}_{0}^{α} ( r ) \cdot g ( {v}_{0}^{α} ( r ) )} .$$

The function ν₀^{α}(r) is strictly increasing in r. Therefore, the expression above is constant for every r if and only if

$$\frac{xg ( x )}{G ( x )}$$

is constant, what leads to

$$G ( {v}_{0} ) = {( \frac{{v}_{0}}{b} )}^{k} .$$

Finally, note that if

$$G ( {v}_{0} ) = {( \frac{{v}_{0}}{b} )}^{k} ,$$

then

$$\frac{1 - {θ}^{α} ( r )}{{θ}^{α} ( r )} = \frac{h ( α )}{k} ,$$

what leads to

$$θ ( r ) = \frac{k}{k + h ( α )}$$

for all r. Q.E.D.

The result above can be understood in the light of monopsonistic price theory. Intuitively, polynomial distribution functions have a constant price elasticity of supply (which measures how many more percentage points of inventory sellers are willing to offer for one percentage increase in expected revenue). Namely, a distribution of the form

$$G ( {v}_{0} ) = {( \frac{{v}_{0}}{b} )}^{k}$$

has a price elasticity of supply equal to k for all opportunity costs ν₀. As it turns out, constant sharing schemes are optimal provided that the price elasticity of supply is constant.

While this specification contains many specific implementation details, these should not be construed as limitations on the scope of any invention or of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the invention. Accordingly, other implementations are within the scope of the following claims.

What is claimed is:

1. A method performed by one or more data processing apparatus, the method comprising:
receiving a request for allocation of a content inventory unit in a content slot provided by a publisher;
receiving a first reserve price for the content inventory unit, where the first reserve price is a minimum payment that the publisher will accept for allocation of the content inventory unit;
determining a share fraction based in part on the first reserve price and based in part on a distribution of past bids for content inventory units in one or more content slots provided by the publisher;
determining a second reserve price based in part on the first reserve price and based in part on a distribution of past bids for content inventory units in one or more content slots provided by the publisher;
receiving one or more bids for the content inventory unit;
comparing at least one of the one or more bids to the second reserve price;
allocating the content inventory unit to a buyer based in part on the one or more bids and the second reserve price; and
transmitting data reflecting the allocation of the content inventory unit to the buyer.

2. The method of claim 1, wherein the sharing fraction is determined based in part on a minimum cost associated with an auction platform.

3. The method of claim 2, wherein the sharing fraction is determined based in part on a convex combination of expected revenue for the publisher and expected revenue for the auction platform.

4. The method of claim 1, wherein the buyer pays the maximum of second reserve price and the second highest bid received for the content inventory unit.

5. The method of claim 1, wherein the content inventory unit is allocated to the buyer based on the results of a truthful auction.

6. The method of claim 1, wherein the second reserve price is determined based in part on a minimum cost associated with an auction platform.

7. The method of claim 6, wherein the second reserve price is determined based in part on a convex combination of expected revenue for the publisher and the auction platform.

8. The method of claim 1, wherein the distribution of past bids is limited to past bids for the content slot of the content inventory unit.

9. The method of claim 1, further comprising:
transmitting to a user device information reflecting a content item supplied by the buyer.

10. The method of claim 1, wherein the second reserve price is also determined based in part on a distribution of past reserve prices received for content inventory units in one or more content slots provided by the publisher.

11. The method of claim 10, wherein the distribution of past reserve prices is limited to past reserve prices for the content slot of the content inventory unit.

12. The method of claim 1, wherein the second reserve price is determined based in part on the sharing fraction.

13. The method of claim 1, further comprising:
determining a payment to the publisher based in part on the share fraction.

14. A method performed by one or more data processing apparatus, the method comprising:
obtaining revenue data for past allocations of content inventory units in a content slot provided by a publisher;
determining an exponent for a power law distribution based on the revenue data;
determining a constant sharing fraction based on the exponent;
allocating a content inventory unit in the content slot to a buyer;
determining a portion of a price paid for the content inventory unit by the buyer that is paid to the publisher using the constant sharing fraction; and
transmitting data reflecting the allocation of the content inventory unit to the buyer.

15. The method of claim 14, wherein determining the exponent for the power distribution comprises using a maximum likelihood method to fit a power law distribution to the revenue data.

16. The method of claim 14, wherein determining the constant sharing fraction based on the exponent comprises dividing the exponent by one plus the exponent.

17. The method of claim 14, wherein the constant sharing fraction is for all content slots provided by the publisher and wherein the method comprises obtaining revenue data for a plurality of content slots provided by the publisher.

18. The method of claim 14, wherein the constant sharing fraction is for the content slot and wherein the revenue data used to determine the exponent is limited to revenue data for the content slot.

19. A system, comprising:
a data processing apparatus; and
a memory coupled to the data processing apparatus having instructions stored thereon which, when executed by the data processing apparatus cause the data processing apparatus to perform operations comprising:
receiving a request for allocation of a content inventory unit in a content slot provided by a publisher;
receiving a first reserve price for the content inventory unit, where the first reserve price is a minimum payment that the publisher will accept for allocation of the content inventory unit;
determining a share fraction based in part on the first reserve price and based in part on a distribution of past bids for content inventory units in one or more content slots provided by the publisher;
determining a second reserve price based in part on the first reserve price and based in part on a distribution of past bids for content inventory units in one or more content slots provided by the publisher;
receiving one or more bids for the content inventory unit;
comparing at least one of the one or more bids to the second reserve price;
allocating the content inventory unit to a buyer based in part on the one or more bids and the second reserve price; and
transmitting data reflecting the allocation of the content inventory unit to the buyer.

20. The system of claim 19, wherein the sharing fraction is determined based in part on a minimum cost associated with an auction platform.

21. The system of claim 20, wherein the sharing fraction is determined based in part on a convex combination of expected revenue for the publisher and expected revenue for the auction platform.

22. The system of claim 19, wherein the buyer pays the maximum of second reserve price and the second highest bid received for the content inventory unit.

23. The system of claim 19, wherein the content inventory unit is allocated to the buyer based on the results of a truthful auction.

24. The system of claim 19, wherein the second reserve price is determined based in part on a minimum cost associated with an auction platform.

25. The system of claim 24, wherein the second reserve price is determined based in part on a convex combination of expected revenue for the publisher and the auction platform.

26. The system of claim 19, wherein the distribution of past bids is limited to past bids for the content slot of the content inventory unit.

27. The system of claim 19, wherein the operations further comprise:
transmitting to a user device information reflecting a content item supplied by the buyer.

28. The system of claim 19, wherein the second reserve price is also determined based in part on a distribution of past reserve prices received for content inventory units in one or more content slots provided by the publisher.

29. The system of claim 28, wherein the distribution of past reserve prices is limited to pasts reserve prices for the content slot of the content inventory unit.

30. The system of claim 19, wherein the second reserve price is determined based in part on the sharing fraction.

31. A system, comprising:
a data processing apparatus; and
a memory coupled to the data processing apparatus having instructions stored thereon which, when executed by the data processing apparatus cause the data processing apparatus to perform operations comprising:
obtaining revenue data for past allocations of content inventory units in a content slot provided by a publisher;
determining an exponent for a power law distribution based on the revenue data;
determine a constant sharing fraction based on the exponent;
allocating a content inventory unit in the content slot to a buyer;
determining a portion of a price paid for the content inventory unit by the buyer that is paid to the publisher using the constant sharing fraction; and
transmitting data reflecting the allocation of the content inventory unit to the buyer.

32. The system of claim 31, wherein determining the exponent for the power distribution comprises using a maximum likelihood system to fit a power law distribution to the revenue data.

33. The system of claim 31, wherein determining the constant sharing fraction based on the exponent comprises dividing the exponent by one plus the exponent.

34. The system of claim 31, wherein the constant sharing fraction is for all content slots provided by the publisher and wherein the operations comprise obtaining revenue data for a plurality of content slots provided by the publisher.

35. The system of claim 31, wherein the constant sharing fraction is for the content slot and wherein the revenue data used to determine the exponent is limited to revenue data for the content slot.

36. A system, comprising:
a network interface configured to receive a request for allocation of a content inventory unit in a content slot provided by a publisher;
a network interface configured to receive a first reserve price for the content inventory unit, where the first reserve price is a minimum payment that the publisher will accept for allocation of the content inventory unit;
means for determining a share fraction based in part on the first reserve price and based in part on a distribution of past bids for content inventory units in one or more content slots provided by the publisher;
means for determining a second reserve price based in part on the first reserve price and based in part on a distribution of past bids for content inventory units in one or more content slots provided by the publisher;
a network interface configured to receive one or more bids for the content inventory unit;
a module configured to compare at least one of the one or more bids to the second reserve price;
a module configured to allocate the content inventory unit to a buyer based in part on the one or more bids and the second reserve price; and
a network interface configured to transmit data reflecting the allocation of the content inventory unit to the buyer.

37. A system, comprising:
a module configured to obtain revenue data for past allocations of content inventory units in a content slot provided by a publisher;
a module configured to determine an exponent for a power law distribution based on the revenue data;
a module configured to determine a constant sharing fraction based on the exponent;
a module configured to allocate a content inventory unit in the content slot to a buyer;
a module configured to determine a portion of a price paid for the content inventory unit by the buyer that is paid to the publisher using the constant sharing fraction; and
a network interface configured to transmit data reflecting the allocation of the content inventory unit to the buyer.

38. The system of claim 37, wherein determining the exponent for the power distribution comprises using a maximum likelihood system to fit a power law distribution to the revenue data.

39. The system of claim 37, wherein determining the constant sharing fraction based on the exponent comprises dividing the exponent by one plus the exponent.

40. The system of claim 37, wherein the constant sharing fraction is for all content slots provided by the publisher and wherein the system comprises a module configured to obtain revenue data for a plurality of content slots provided by the publisher.

41. The system of claim 37, wherein the constant sharing fraction is for the content slot and wherein the revenue data used to determine the exponent is limited to revenue data for the content slot.
